(19) United States
(12) Patent Application Publication
(10) Pub. No.: US 2011/0314075 A1
(43) Pub. Date: Dec. 22, 2011

(54) METHOD AND APPARATUS FOR MANAGING DISTRIBUTED COMPUTATIONS WITHIN A COMPUTATION SPACE

(75) Inventors: Sergey Boldyrev, Soderkulla (FI); Ian Justin Oliver, Soderkulla (FI); Mika Juhani Mannermaa, Burlington, MA (US); Ora Lassila, Hollis, NH (US); Seppo Juhani Pyhälammi, Helsinki (FI)

(73) Assignee: Nokia Corporation, Espoo (FI)

(21) Appl. No.: 12/818,958

(22) Filed: Jun. 18, 2010

(51) Int. Cl. G06F 15/16

(52) U.S. Cl. 709/201

(57) ABSTRACT

An approach is provided for providing operations for manipulation of distributed computations. A computations closure management infrastructure determines to receive a request for specifying one or more operations to perform on one or more computation spaces, wherein the one or more computation spaces represent one or more computational processes as one or more graphs within the respective one or more computation spaces. The computation closures management infrastructure determines to retrieve the one or more computation spaces, the one or more graphs within the one or more computation spaces, one or more subgraphs of the one or more graphs, or a combination thereof. The computation closures management infrastructure determines to apply the one or more operations on the one or more computation spaces, the one or more graphs, the one or more subgraphs, or a combination thereof to update at least one of the one or more computation spaces, to generate at least one additional computation space, or a combination thereof.

### BACKGROUND

Mobile devices with various methods of connectivity are now for many people becoming the primary gateway to the internet and also a major storage point for personal information. This is in addition to the normal range of personal computers and furthermore sensor devices plus internet based providers. Combining these devices along with their applications and the information stored by those applications is a major challenge of interoperability. This can be achieved through numerous, individual and personal information spaces in which persons, groups of persons, etc. can place, share, interact and manipulate webs of information with their own locally agreed semantics.

Furthermore, in addition to information, the information spaces may be combined with webs of shared and interactive computations or computation spaces so that the devices having connectivity to the computation spaces can have the information in the information space manipulated within the computation space environment and the results delivered to the device, rather than the whole process being performed locally in the device. These combined information spaces and computation spaces often referred to as smart spaces, are extensions of the ‘Giant Global Graph’ in which one can apply semantics and reasoning at a local level.

In one embodiment, information and computation spaces are working spaces respectively embedded with distributed information and computation infrastructures spanned around computers, information appliances, processing devices and sensors that allow people to work efficiently through access to information and computations from computers or other devices. An information space or a computation space can be rendered by the computation devices physically presented as heterogeneous networks (wired and wireless). However, despite the fact that information and computation presented by the respective spaces can be distributed with different granularity, still there are challenges to achieve scalable high context information processing within heterogeneous environments such as Nokia's Mobile Clouds®. One such challenge is to create adaptive computation platforms to enhance the information processing power of a device as it interacts with various external information processors. To overcome this challenge, approaches for creating adaptive computation platforms to provide granular and reflective process migration in combination with information processors are introduced. However, as the number and complexity of computations increase, the challenge of keeping track of the combined and/or extracted computations among the various computation spaces also increases.

### Some Example Embodiments

Therefore, there is a need for an approach for providing operations for manipulation of distributed computations at the level of the computation spaces while preserving the history of operations over the computation spaces and the semantic agreements or rules contained within the information spaces.

According to one embodiment, a method comprises determining to receive a request for specifying one or more operations to perform on one or more computation spaces, wherein the one or more computation spaces represent one or more computational processes as one or more graphs within the respective one or more computation spaces. The method also comprises determining to retrieve the one or more computation spaces, the one or more graphs within the one or more computation spaces, one or more subgraphs of the one or more graphs, or a combination thereof. The method further comprises determining to apply the one or more operations on the one or more computation spaces, the one or more graphs, the one or more subgraphs, or a combination thereof to update at least one of the one or more computation spaces, to generate at least one additional computation space, or a combination thereof.

According to another embodiment, an apparatus comprising at least one processor, and at least one memory including computer program code, the at least one memory and the computer program code configured to, with the at least one processor, cause, at least in part, the apparatus to determine to receive a request for specifying one or more operations to perform on one or more computation spaces, wherein the one or more computation spaces represent one or more computational processes as one or more graphs within the respective one or more computation spaces. The apparatus is also caused to determine to retrieve the one or more computation spaces, the one or more graphs within the one or more computation spaces, one or more subgraphs of the one or more graphs, or a combination thereof. The apparatus is further caused to determine to apply the one or more operations on the one or more computation spaces, the one or more graphs, the one or more subgraphs, or a combination thereof to update at least one of the one or more computation spaces, to generate at least one additional computation space, or a combination thereof.

According to another embodiment, a computer-readable storage medium carrying one or more sequences of one or more instructions which, when executed by one or more processors, cause, at least in part, an apparatus to determine to receive a request for specifying one or more operations to perform on one or more computation spaces, wherein the one or more computation spaces represent one or more computational processes as one or more graphs within the respective one or more computation spaces. The apparatus is also caused to determine to retrieve the one or more computation spaces, the one or more graphs within the one or more computation spaces, one or more subgraphs of the one or more graphs, or a combination thereof. The apparatus is further caused to determine to apply the one or more operations on the one or more computation spaces, the one or more graphs, the one or more subgraphs, or a combination thereof to update at least one of the one or more computation spaces, to generate at least one additional computation space, or a combination thereof.

According to another embodiment, an apparatus comprises means for determining to receive a request for specifying one or more operations to perform on one or more computation spaces, wherein the one or more computation spaces represent one or more computational processes as one or more graphs within the respective one or more computation spaces. The apparatus also comprises means for determining to retrieve the one or more computation spaces, the one or more graphs within the one or more computation spaces, one or more subgraphs of the one or more graphs, or a combination thereof. The apparatus further comprises means for determining to apply the one or more operations on the one or more computation spaces, the one or more graphs, the one or more subgraphs, or a combination thereof to update at least one of the one or more computation spaces, to generate at least one additional computation space, or a combination thereof.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing operations for manipulation of distributed computations, according to one embodiment;

FIG. 2 is a diagram of the components of a computation closures management infrastructure, according to one embodiment;

FIG. 3 is a flowchart of a process for providing operations for manipulation of distributed computations, according to one embodiment;

FIGS. 4A-4B are diagrams of computation closures recycling among devices, according to one embodiment;

FIG. 5 is a flowchart of a process for constructing distributed computations, according to one embodiment;

FIGS. 6A-6C are diagrams of computation distribution, according to various embodiments;

FIG. 7 is a diagram of user equipment set, according to one embodiment;

FIG. 8 is a diagram of process migration, according to one embodiment;

FIG. 9 is a diagram of process migration from a device to another device, according to one embodiment;

FIG. 10 is a diagram of alignment between layers of a system providing distributed computations, according to one embodiment;

FIG. 11A is a flowchart of a process for applying a split operation on a computation space, according to one embodiment;

FIG. 11B is a flowchart of a process for applying a merge operation on a computation space, according to one embodiment;

FIG. 12 is a flowchart of a process for defining a boundary for a computation space, according to one embodiment;

FIG. 13A is a flowchart of a process for applying a split operation on a computation space considering boundary and history information, according to one embodiment;

FIG. 13B is a flowchart of a process for applying a merge operation on a computation space considering boundary and history information, according to one embodiment;

FIGS. 14A-14B are a flowchart and a diagram, respectively, of a process for applying a projection operation on a computation space, according to one embodiment;

FIG. 15 is a flowchart of a process for applying a projection operation on a computation space using an equation, according to one embodiment;

FIGS. 16A-16B are a flowcharts and a diagram, respectively, of a process for applying an injection operation on a computation space, according to one embodiment;

FIG. 17 is a flowchart of a process for applying an injection operation on a computation space using an equation, according to one embodiment;

FIGS. 18A-18D are diagrams of example use cases for applying a split, merge, projection, and injection operation, respectively, on a computation space, according to various embodiments;

FIG. 19 is a diagram of hardware that can be used to implement an embodiment of the invention;

FIG. 20 is a diagram of a chip set that can be used to implement an embodiment of the invention; and

FIG. 21 is a diagram of a mobile terminal (e.g., handset) that can be used to implement an embodiment of the invention.

### DESCRIPTION OF SOME EMBODIMENTS

Examples of a method, apparatus, and computer program for providing operations for manipulation of distributed computations are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term information space refers to an aggregated information set from different sources. This multi-sourcing is very flexible since it accounts and relies on the observation that the same piece of information can come from different sources. For example, the same information (e.g., contact information for a particular contact) can appear in the same information space from multiple sources (e.g., a locally stored contacts database, a public directory, a work contact database, etc.). In one embodiment, information within the information space or smart space is represented using Semantic Web standards such as Resource Description Framework (RDF), RDF Schema (RDFS), OWL (Web Ontology Language), FOAF (Friend of a Friend ontology), rule sets in RuleML (Rule Markup Language), etc. Furthermore, as used herein, RDF refers to a family of World Wide Web Consortium (W3C) specifications originally designed as a metadata data model. It has come to be used as a general method for conceptual description or modeling of information that is implemented in web resources; using a variety of syntax formats.

As used herein, the term reflective computing refers to the capability of a system to reason or act upon itself. A reflective system is a system that provides a representation of its own behavior which is amenable to inspection and adaptation. Reflection enables both inspection and adaptation of systems at run time. Inspection allows the current state of the system to be observed while adaptation allows the system's behavior to be altered at run time to better. Although various embodiments are described with respect to reflective computing, it is contemplated that the approach described herein may be used with other computation systems and architectures.

As used herein, the term granular processing refers to how finely a particular computational process is subdivided (e.g., a minimum unit of code that can be used to perform a task or function of the process). By way of example, granularity (e.g., a minimum level of granularity, different levels of granularity, etc.) of the processes can be defined by the developer of the process or can be dynamically determined by a system.

As used herein, the term computation closure identifies a particular computation procedure together with relations and communications among various processes including passing arguments, sharing process results, flow of data and process results, etc. The computation closures (e.g., a granular reflective set of instructions, data, and/or related execution context or state) provide the capability of slicing of computations for processes and transmitting the computation slices between devices, infrastructures and information spaces.

As used herein, the term computation space refers to an aggregated set of computation closures from different sources. In one embodiment, computations within the computation space is represented using Semantic Web standards such as Resource Description Framework (RDF), RDF Schema (RDFS), OWL (Web Ontology Language), FOAF (Friend of a Friend ontology), rule sets in RuleML (Rule Markup Language), etc. In one embodiment, an information space including aggregated computation closures is also known as a computation space.

As used herein, the term “smart space” refers to a combination of one or more information spaces and one or more computation spaces, wherein the computation spaces comprise computation closures that operate on the information in the information spaces. Although various embodiments are described with respect to information spaces, computation spaces and RDF, it is contemplated that the approach described herein may be used with other structures and conceptual description methods used to create models of information and computation.

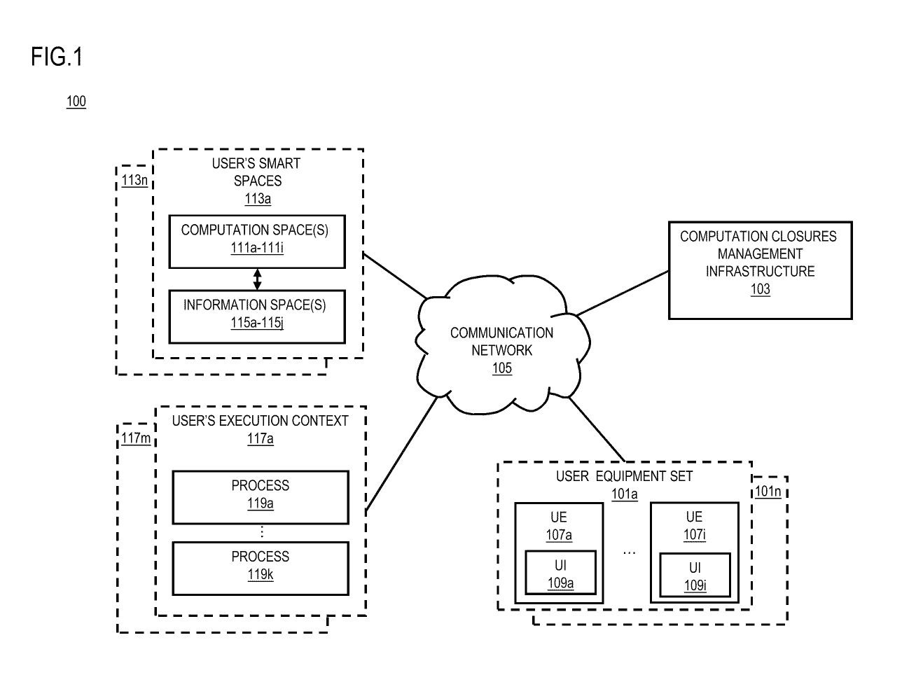

FIG. 1 is a diagram of a system capable of providing operations for manipulation of distributed computations, according to one embodiment. As previously described, a smart space consists of information and computation spaces each consisting of several distributed devices that communicate information and computation closures (e.g. RDF graphs) via a shared memory. A device within a computation space environment may store computation closures locally in its own memory space or publish computation closures on a globally accessible environment within the smart space. In the first case, the device is responsible for any process needed for combination or extraction of computations, while in the second case the processes can be conducted by the globally accessible environment. However, in many cases, the computation closures may be organized as lists or sets that can include many computation elements (e.g., preliminary computation closures related to a goods inventory operation, a contact list management, etc.).

The basic concept of computation space technology provides access to distributed computations for various devices within the scope of the smart space, in such a way that the distributed nature of the computations is hidden from users and it appears to a user as if all the computations are performed on the same device. The computation space also enables a user to have control over computation distribution by transferring computations between devices that the user has access to. For example, a user may want to transfer computations among work devices, home devices, and portable devices. Current technologies enable a user of a mobile device to manipulate contexts such as data and information via the elements of a user interface of their user equipment. However, a user often does not have control over the distribution of computations and processes related to or acting on the data and information within the computation space. In other words, a computation space in general does not provide a user (e.g., an owner of a collection of information or computation closures distributed over the computation space) with the ability to control distribution of related computations and processes of, for instance, applications acting on the information. For example, a contact management application that processes contact information distributed within one or more information or computation spaces generally executes on a single device (e.g., with all processes and computations of the application also executing on the same device) to operate on the distributed information. In some cases (e.g., when computations are complex, the data set is large, etc.), providing a means to also distribute the related computations in addition to the information space is advantageous.

This goal is achieved by introduction of the capability to construct, distribute, and aggregate computations as well as their related data. More specifically, to enable a user of a smart space, who connects to the smart space via one or more user devices, to distribute computations among the one or more user devices or other devices with access to the information space, each computation is deconstructed to its basic or primitive processes or computation closures. As used herein, computation closures refer to computation procedures together with relations and communications among various computations including passing arguments, sharing process results, flow of data and process results, etc. Once a computation is divided into its primitive computation closures, the processes within or represented by each closure may be executed in a distributed fashion and the processing results can be collected and aggregated into the result of the execution of the initial overall computation.

In one embodiment, each high context set of computations can be represented as closed sets of processes (e.g. transitive closures) such that closures can be executed separately (e.g. through distributed processing equipments). The transitive closures can be traversed in order to present the granular reflective processes attached to each particular execution context. The mechanism of computation spaces environment provides distributed deductive closures as a recyclable set of pre-computed, computation closures that can be distributed among various devices and infrastructures or being shared among the users of one or more smart space by being stored on any storage locations related to the information spaces associated with the smart spaces.

In another embodiment, the provided distributed computations may be archived in one or more repositories throughout the computation space to be accessible for future use. In this embodiment, the smart spaces may search the repositories for previously generated standalone computations before attempting to generate them. This mechanism provides recyclable computations that can be retrieved and combined into sets to be utilized for providing various services. However, for efficient and accurate use of the distributed computations there is the need for combining (merging) the distributed computations from different sources into a computation space. Furthermore, due to several reasons such as security issues, changing agreements and so on, it could be necessary for a computation space to be split into two or more smaller spaces. The process of splitting one computation space may be volatile, meaning that merging the split spaces together again may not produce the initial space, since some links between computations could be lost. Conventionally, there is no strict order to justify “split-merge” or “merge-split” procedures. The process involves high volatility in terms of which split spaces can be merged and which solid spaces (merged earlier) can be split without damaging the initial contents.

Furthermore, in a computation space, computations requested by a user may be distributed over several repositories, and therefore in order to deduce a sub-set of computations, there is the need for extracting (e.g., projecting) or combining (e.g., injecting) the computations from different sources into a new computation space. In many occasions keeping track of the process of extracting part of an existing computation space while keeping track of the extraction (e.g., projection) may be used in place of a simple split or extraction where no computation related to the extraction is maintained. In other words, the process of projection maintains a memory (e.g., a log of what computation is extracted and where the computation has been sent) whereas a split operation does not maintain such memory. Also many applications of computations may involve returning the computation content of an extracted part of the computation space back to the original computation space (injection). To enable the return of computations, the issue of keeping the computations up to date with the propagation of computations among computation spaces is important.

As shown in FIG. 1, the system 100 comprises one or more sets 101a-101n of user equipment (UEs) UE 107a-107i, each having connectivity to a computation closures management infrastructure 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 107a-107i are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 107a-107i can support any type of interface to the user (such as “wearable” circuitry, etc.).

In one embodiment, the UEs 107a-107i are respectively equipped with one or more user interfaces (UI) 109a-109i. Each UI 109a-109i may consist of several UI elements (not shown) at any time, depending on the service that is being used. UI elements may be icons representing user contexts such as information (e.g., music information, contact information, video information, etc.), functions (e.g., setup, search, etc.) and/or processes (e.g., download, play, edit, save, etc.). Additionally, each UI element may be bound to a context/process by granular migration. In one embodiment, granular migration enables processes to be implicitly or explicitly migrated between devices, computation spaces, and other infrastructure. The process migration can be initiated for example by means of single-cast (e.g., to just another UE 107) or multicast (e.g., to multiple other UEs 107). Additionally, process migration may be triggered via gesture recognition, wherein the user preselects a particular set of UI elements and makes a gesture to simulate “pouring” the selected UE elements from one device to another.

As seen in FIG. 1, a user of UEs 107a-107i may own, use, or otherwise have access to various pieces of computations distributed over a smart space 113a of computation spaces 111a-111i and information spaces 115a-115j where each of the one or more computation spaces 111a-111i include one or more computation closures. The user can access the computations via the set 101a consisting of UEs 107a-107i wherein each UE 107a-107i is equipped with one or more user interfaces (UI) 109a-109i. Furthermore, each UE 107a-107i may have access to execution context 117a consisting of processes 119a-119k that can be used to manipulate the information stored in information spaces 115a-115j and produce results requested by the user of the UE 107.

In one embodiment, the computation closures management infrastructure 103 consists of information about executions 117a and processes 119a-119k for each UE 107a-107i. The information may include information such as input parameters, input types and formats, output types and formats, process structure, flow of data, communication means and parameter passing among processes 119a-119k, etc.

The computations information enables a UE 107a-107i to divide computations into their primary computation closures, wherein each computation closure can be executed separately from other computation closures belonging to the same computation. For example, computations related to a music download may be divided into a search process for finding the most suitable download site, an verification process to determine whether the user is eligible for downloading from the site, an initialization process for verifying adequate resource (e.g. storage space) for the file to be downloaded, a process for verifying the type of the music file and associated playing environment, a process for determining whether the player is available on the UE 107, a process to activate the player after completion of the download, etc. In one embodiment, these processes or the computation closure derived from the processes 119a-119k may be stored in the computation spaces 111a-111i and executed independently from each other. Following execution of the independent processes, the data and parameters resulting from the execution can be exchanged to be able to aggregate results and make operation of the music application available in a smart space environment. Moreover, division of the music-related computations into independent processes may vary based on factors such characteristics of the UE, restrictions of the download site, the music file type, the player type and requirements, etc. In one embodiment, division of computations into their primary processes or computation closures is managed by the computation closures management infrastructure 103. In addition, the computation closures are serialized into, for instance, an information syntax such as RDF triples before being stored via a computation space.

By way of example, the UEs 107a-107i of sets 101a-101n, computation closures management infrastructure 103, and the smart spaces 113a-113n communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

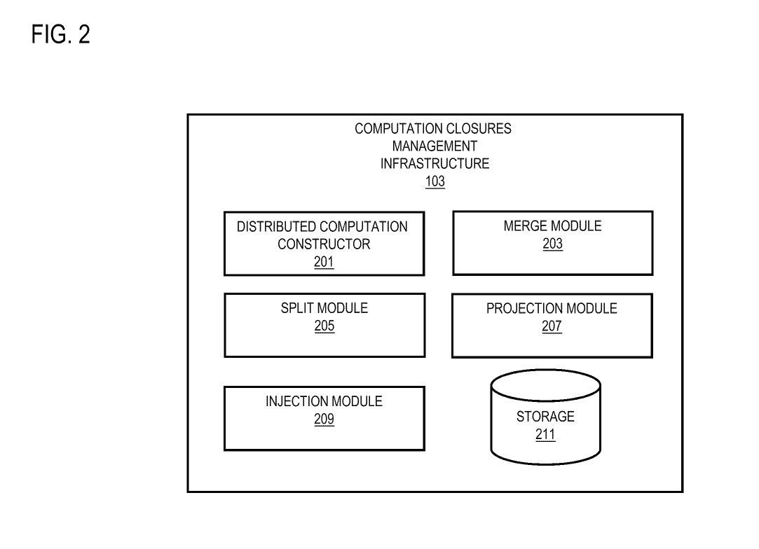

FIG. 2 is a diagram of the components of a computation closures management infrastructure, according to one embodiment. By way of example, the computation closures management infrastructure 103 includes one or more components for construction, aggregation and manipulation of distributed computations. It is contemplated that the functions of these components may be combined in one or more components or performed by other components of equivalent functionality. In this embodiment, the computation closures management infrastructure includes a distributed computation constructor 201, a merge module 203, a split module 205, a projection module 207, and injection module 209, and storage 211.

The distributed computation constructor 201 receives a request for computation distribution. In one embodiment, the request may have been generated by a UE 107 based on a user gesture such as for example pushing an icon of the UI 109 towards another UE 107 which may indicate that the user wants the process associated with the icon to be executed in the other UE 107. In another embodiment, the request for computation distribution may be generated by a component of an information space linked to the UE 107, by an independent component having connectivity to the UEs 107 and the information spaces via the communication network 105, or a combination thereof.

The request for computation distribution may include information about the computation that is going to be distributed, including input, output, processing requirements, etc. The request may also include information about the origin and the destination of a computation. For example, a user may want to distribute the computations associated with encoding a video file from one format to another (a typically highly processor and resource intensive task). In this example, the video file is stored in the user's information space 115a-115j or otherwise available over the communication network 105 (e.g., downloaded from a source over the Internet), and therefore accessible from the UEs 107. Accordingly, the user may make a manual request to distribute the computations associated with the video encoding to one or more other devices, a backend server, cloud computing components, and/or any other component capable of performing at least a portion of the encoding functions. By way of example, the manual request may be made via a graphical user interface by dragging an icon or other depiction of the computations to command areas depicted in the user interface. These command areas, for instance, may be representative of physical or virtual locations of the other UEs 107 or devices that can support or perform the distributed computations. In other cases, the distribution can be initiated automatically by the system 100 based on one or more criteria via a request generator (not shown) in conjunction with the computation closure management infrastructure 103.

In one embodiment, following the receipt of the computation distribution request, the distributed computation constructor 201 retrieves and analyzes the information regarding the computation and determines the execution components involved in the computation. For the above example, the execution context may include video playing, audio playing, etc and related settings, parameters, memory states, etc. The identified execution context may be stored in a storage 211, in a storage space associated with the smart space 113a-113n, used directly by the distributed computation constructor 201, or a combination thereof.

In another embodiment, the distributed computation constructor 201 breaks each execution context into its primitive or basic building blocks (e.g., primitive computation closures or closure primitives) or the sub-processes of the whole execution context. For example the video playing execution may be decomposed into computations or processes that support tasks such as, searching for available players, check the compatibility of video file with the players found, select the player, activate the selected player, etc. Each of the decomposed sub-processes may have certain specifications and requirements to effect execution of the processes in a computation space 111 such as input and output medium and type, how parameters or results are to be passed to other processes, runtime environments, etc. In order for a process to be executed in a standalone fashion without being part of a larger process, a computation closure can be generated for the process. A computation closure includes the process and the specifications and requirements associated with the process that can be executed independently for subsequent aggregation.

In one embodiment, the distributed computation constructor 201 generates computation closures for the extracted sub-processes and stores the closures in computation spaces 111a-111i. The stored closures may be used for slicing computations into smaller independent processes to be executed by various available UEs 107a-107i, using the data which may be stored on the distributed information spaces 115a-115j.

In another embodiment, the distributed computation constructor 201 utilizes the defined closures and produces the serialized granular computation elements.

In one embodiment, the closure serialization may be generated and stored using Resource Description Framework (RDF) format. RDF is a family of World Wide Web Consortium (W3C) specifications originally designed as a metadata data model. It has come to be used as a general method for conceptual description or modeling of information that is implemented in web resources; using a variety of syntax formats. The underlying structure of any expression in RDF is a collection of triples, each consisting of three disjoint sets of nodes including a subject, a predicate and an object. A subject is an RDF URI reference (U) or a Blank Node (B), a predicate is an RDF URI reference (U), and an object is an RDF URI reference (U), a literal (L) or a Blank Node (B). A set of such triples is called an RDF graph. Table 1 shows an example RDF graph structure.

TABLE 1

| Subject | Predicate | Object |
|---|---|---|
| uri://....../rule#CD- | rdf:type, | uri://............/Rule |
| introduction, | | |
| uri://....../rule#CD- | uri://....../rule#assumption, | “c” |
| introduction, | | |

The granularity may be achieved by the basic format of operation (e.g. RDF) within the specific computation environment. Furthermore, the reflectivity of processes (i.e. the capability of processes to provide a representation of their own behavior to be used for inspection and/or adaptation) may be achieved by encoding the behavior of the computation in RDF format. Additionally, the context may be assumed to be partly predetermined and stored as RDF in the computation space and partly be extracted from the execution environment. It is noted that the RDF structures can be seen as subgraphs, RDF molecules (i.e., the building block of RDF graphs) or named graphs in the semantic information broker (SIB) of information spaces.

In certain embodiments serializing the closures associated with a certain execution context enables the closures to be freely distributed among multiple UEs 107 and/or devices including remote processors associated with the UEs 107 by one or more user smart spaces 113a-113n via the communication network 105 or between one or more UEs 107 and the computation spaces 111a-111i. The processes of closure assigning and migration to run-time environments may be performed automatically based on factors such as the required processing power for each process, system load, capabilities of the available run-time environments, etc. Following the migration of each computation closure to its designated run-time environment, the run-time environment may communicate with the computation closure management infrastructure 103 regarding the receipt of the closures through components referred to as agents. Upon receiving the communication from an agent, distributed computation constructor 201 verifies the consistency of the closures which, as explained before, are in RDF graph format. The consistency verification ensures that the computation closure content for each closure is accurate, contains all the necessary information for execution, the flow of data and instructions is correct according to the original computation and has not been damaged during the serialization and migration process. If the closures pass the consistency check or is otherwise approved, the distributed computation constructor 201 reconstructs each component of the execution context based on the content of the computation closures. Once an execution context is reconstructed, the agents of the run-time environment can resume the execution of the execution context component that it initially received as computation closures in RDF format. In one embodiment, the resumption of the execution may be combined with one or more other results of other executions of at least a portion of the execution context.

The communication network 105 may have connectivity to one or more execution contexts 117a-117m that could be physically apart in distant locations from each other but accessible by user devices 101a through the communication network 105. Each user may have one or more sets of executions 117a-117m based on user requirements. In one embodiment, the distributed computation constructor 201 generates computation closures for the execution context for each user. The generated computation closures are stored in user specific computation spaces 111a-111i by the computation closures management infrastructure 103. The computation spaces 111a-111i are manages and maintains under the supervision of the computation closures management infrastructure 103.

According to one embodiment, a computation space S is defined as a 3-tuple containing a unique name n, a graph I of computations, often referred to as content of the computation space, nominally conforming to, for example, Resource Description Framework (RDF) semantics, and a set ρ of rewrite rules over that computations:

S→(n,I,ρ)

As shorthand representation, Sₙ is used to refer to computation space name as similarly Iₙ and ρₙ refer to the computation content and rules for computation space n respectively. It is assumed that each computation space has a unique name and there exists a set of known computation spaces.

In one embodiment, computation spaces can be represented using Semantic Web standards such as Resource Description Framework (RDF), RDF Schema (RDFS), OWL (Web Ontology Language), FOAF (Friend of a Friend ontology), rule sets in RuleML (Rule Markup Language), etc.

The operations to insert or remove computations from a computation space are assumed to exist. The basic form of these operations are defined as follows:

insert(n,g)→(n,I∪g,ρ) (A)

remove(n,g)→(n,I−g,ρ) (B)

where g is a graph of computations.

The deductive closure for Sₙ is denoted as Δₙ where Δ is the deductive closure mechanism. In set theory, a set of objects, O, is said to exhibit closure or to be closed under a given operation, R, provided that for every object, x, if x is a member of O and x is R-related to any object, y, then y is a member of O.

Querying a computation space is made via a query q and the result returned is a subgraph of the space computation graph I under a deductive closure that conforms to q. All queries on a computation space are actually over the deductive closure Δ and not the base computation content I. A query q on computation space n returns a subgraph that conforms to q.

query(n,q)→Δₙ|=q

The given operations can be composed together to form more complex operations such as “update”. The update of computations in a computation space can be expressed as the combination of remove and insert. However, if the intersection of inserted subgraph and removed subgraph is not empty, the order in which insert and remove are applied will affect the operation result. For example, given a graph containing a single element {a}, the operation to insert a graph {b} and then immediately remove the graph {b} as an atomic operation results in the graph {a} where if the ordering of insertion and removal is reversed, the graph {a b} is obtained. Therefore, update operation as defined below, returns a valid result only if the intersection of inserted and deleted subgraphs is empty:

$$update ( n , {g}_{i} , {g}_{r} ) \to \{ \begin{matrix}remove ( n , {g}_{r} ) ; insert ( n , {g}_{i} ) : & {g}_{i} ⋂ {g}_{r} = ϕ \\ ⊥ : & {g}_{i} ⋂ {g}_{r} \neq ϕ\end{matrix}$$

As seen in FIG. 1, each user has one or more computation spaces 111a-111i that store computations deduced from execution context 117a-117m by computation closures management infrastructure 103 through local or global reasoning by distributed computation constructor 201.

In one embodiment, split module 205 manages and conducts the process of breaking and reconfiguring user's current computation spaces into smaller computation spaces. This process can be performed in various manners, such as removing all computation and creating multiple individual smaller or even empty computation spaces or making complete copies of current computation spaces. Merge module 203 manages and conducts the process of binding individual computation spaces together to create a larger computation space. These individual bodies of computations may be overlapping in terms of their content. User devices can interact simultaneously with many discrete computation spaces. In this case the total computation available for a given computation space is the union of the computation closure over all the individual bodies of computations. Projection module 207 manages and conducts the process of projecting and partitioning computation spaces similar to split with the difference that it keeps track of projected computation spaces. Injection module 209 manages and conducts the process of returning the contents of a projected computation space back to its original computation space.

In one embodiment, metadata (data about other data) such as data describing computation spaces, users' queries, etc. are stored in storage 211. The computation closures management infrastructure 103 uses this data for handling computation spaces.

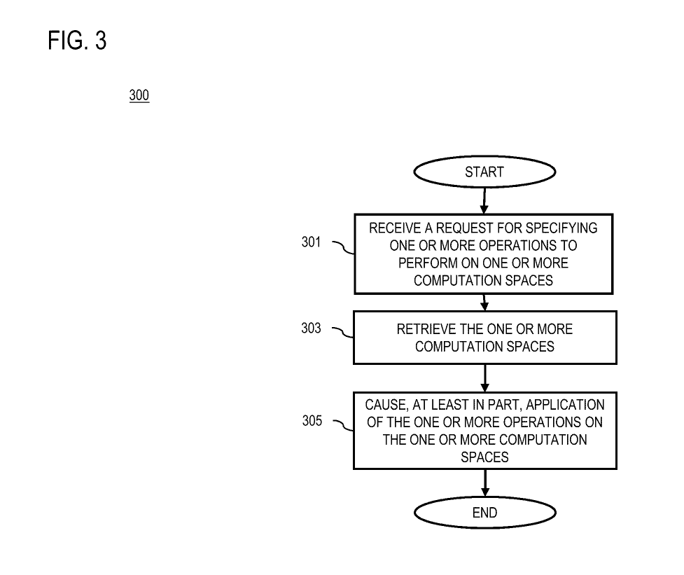

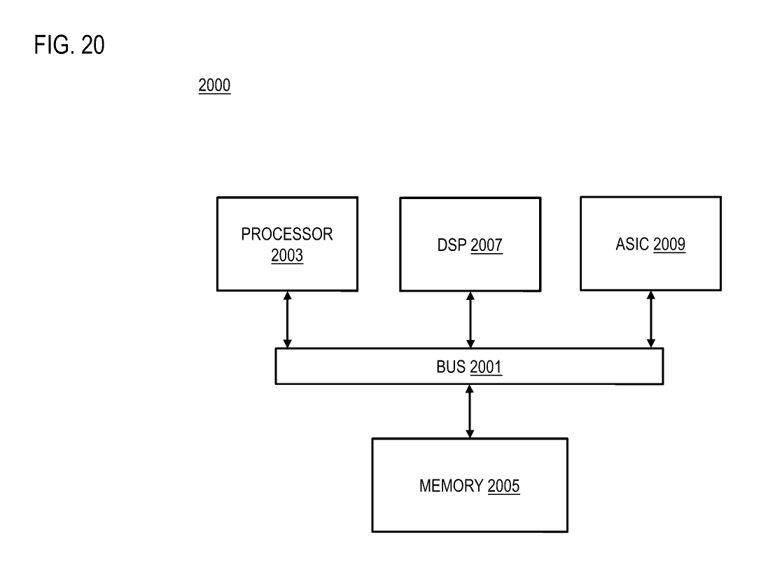

FIG. 3 is a flowchart of a process for providing operations for manipulation of distributed computations, according to one embodiment. In one embodiment, the computations closures management infrastructure 103 performs the process 300 and is implemented in, for instance, a chip set including a processor and a memory as shown in FIG. 20. In step 301, the computation closures management infrastructure 103 receives a request for specifying one or more operations to perform on one or more computation spaces. The request may be generated internally by the distributed computation constructor 201 in response to a request from a UE 107a-107n for one or more user execution contexts 117a-117m to be performed. As explained above in FIG. 2, the distributed computation constructor 201 may decompose the executions and define the computation closures required for the performance of each user execution context 117a-117m. In one embodiment, instead of generating computation closures, the distributed computation constructor 201 may refer to one or more computation space 111a-111i and retrieve computation closures previously generated and use them for performing the user execution. For the distributed computation constructor 201 to be able to manipulate the computation spaces and extract one or more suitable computation closures for an execution context, operations on computation spaces need to be defined. Operations such as split, merge, projection and injection manipulate the RDF graphs that represent computation closures. Upon receiving a request for one or more operations from the distributed computation constructor 201, the computation closures management infrastructure 103, per step 303 retrieves the computation spaces 111a-111i on which the operations need to be performed. In step 305 the computation closures management infrastructure 103 initiates the requested operation by activating one of the modules split 205, merge 203, projection 207 or injection 209 associated with the requested operation. The operation results may be stored in the storage 211, in a computation space 111a-111i or a combination thereof.

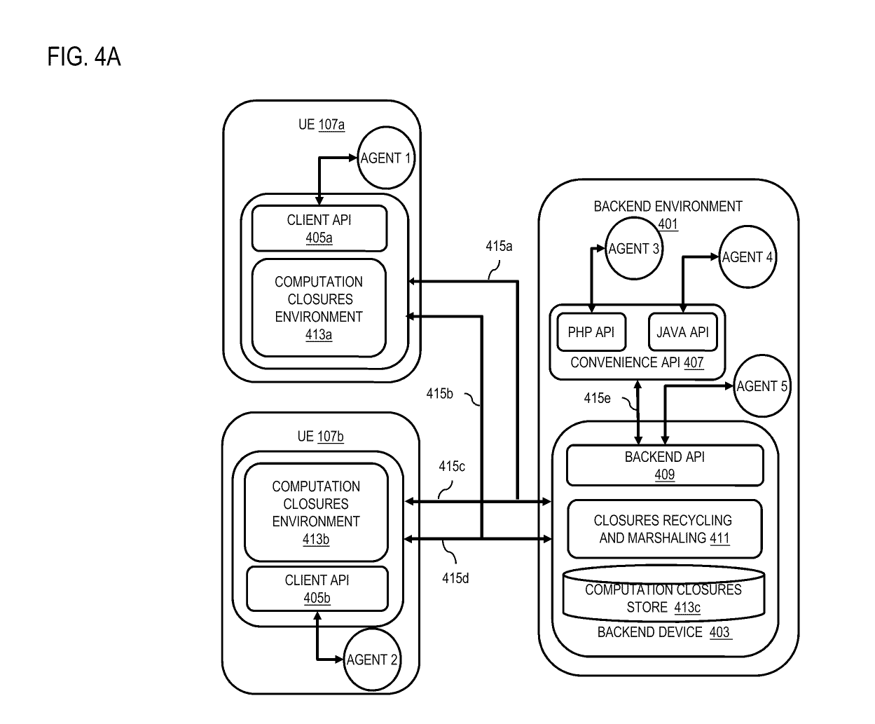

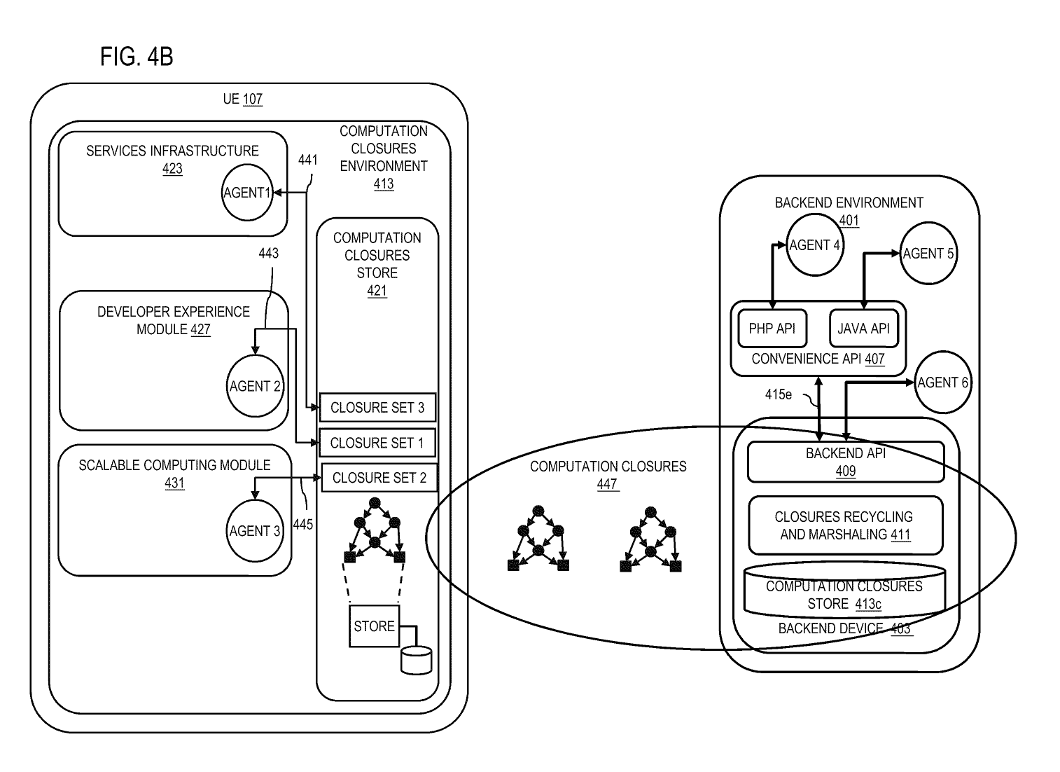

FIGS. 4A-4B are diagrams of computation closures recycling among devices, according to one embodiment. In one embodiment, in FIG. 4A, the backend environment 401 may be a virtual run-time environment within the user's smart spaces 113a-113n or on one UE 107 associated with the user. The backend environment 401 may include one or more backend devices 403 and one or more Application Programming Interface (API) such as a convenience API 407 that may include APIs tailored to the software development environments used (e.g. JAVA, PHP, etc.). Each API enables interaction between devices and components within the backend environment 401. For example, backend API 409 enables interaction between the backend device 403 and Agent5, and convenience API 407 enables interaction between the backend device 403 and agents Agent3 and Agent4, wherein each agent is a set of processes that handle computation closures within the backend environment 401. As seen in the example of FIG. 4 Agent3 works under PHP while Agent4 is a JAVA process. Each of the UEs 107a and 107b has a computation closure environment 413a and 413b which are part of a computation space 111. Arrows 415a-415e represent distribution of computation closures among the environments 413a, 413b and the computation closure store 413c. The computation closures store 413c is a repository of computation closures that can be accessed and used by all the UEs having connectivity to the backend environment 401.

In one embodiment, the backend device 403 may be equipped with a closure recycling and marshaling component 411 that monitors and manages any access to the computation closure store 413. In other embodiments the closure recycling and marshaling (i.e. standardization for uniform use) may be a function of the computation closures management infrastructure 103.

In one embodiment, the computation closures within environments 413a, 413b and the computation closures store 413c may be composed based on anonymous function objects and automatically created by a compiling system using methods for generating anonymous function objects such as lambda expressions.

FIG. 4B is an expanded view of a computation closure environment 413 as introduced in FIG. 4A. The computation closure environment 413 may be composed of one or more computation closure generating components. In one embodiment the computation closure environment 413 has a services infrastructure 423 that provides various services for the user of the UE 107. The services may include any application that can be performed on the UE 107 such as, games, music, text messaging, voice calls, etc. In one embodiment, the service infrastructure 423 provides support for closure based granular reflective processes under the supervision of a computation closures management infrastructure 103 as discussed in FIG. 1. The agent Agent1 retrieves the computation closures required by the services infrastructure 423 from the computation closures store 421 and stores the newly generated computation closures by the services infrastructure 423 into the computation closures store 421 for recycling purposes per arrow 441.

In another embodiment, the computation closure environment 413 has a developer experience module 427 that provides various tools for a developer for manipulating services offered by the UE 107. The tools may include standardized and/or abstract data types and services allowing the developers to chain processes together across development platforms. In one embodiment, the developer experience module 427 provides cross platform support for abstract data types and services under the supervision of a computation closures management infrastructure 103 as discussed in FIG. 1. The agent Agent2 retrieves the computation closures required by the developer experience module 427 from the computation closures store 421 and stores the newly generated computation closures by the developer experience module 427 into the computation closures store 421 for recycling purposes per arrow 443.

In yet another embodiment, the computation closure environment 413 has a scalable computing module 431 that provides an abstract wrapper (i.e. monadic wrapper) for the execution context 117. This abstraction provides computation compatibility between the execution context 117 and the UE 107. The abstract wrapper may provide scheduling, memory management, system calls and other services for various processes associated with the execution context 117. These services are provided under the supervision of the computation closures management infrastructure 103 as discussed in FIG. 1. The agent Agent3 retrieves the computation closures required by the scalable computing module 431 from the computation closures store 421 and stores the newly generated computation closures by the scalable computing module 431 into the computation closures store 421 for recycling purposes per arrow 445. In one embodiment, the backend environment 401 may access the computation closure store 421 and exchange one or more computer closures 447 between the computation closures store 421 and the backend computation closures store 413c.

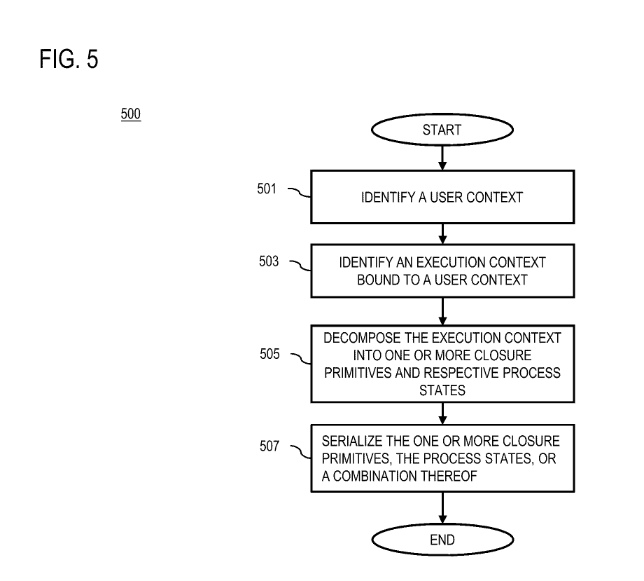

FIG. 5 is a flowchart of a process for constructing distributed computations, according to one embodiment. In one embodiment, the distributed computation constructor 201 performs the process 500 and is implemented in, for instance, a chip set including a processor and a memory as shown in FIG. 20.

In one embodiment, per step 501, the distributed computation constructor 201, identifies a user context. A user context as used herein refers to the type of activity that user is conducting on one or more UEs 107. A user context may be listening to music, talking on the phone, text messaging, playing a game, working with an application, etc. In step 503, distributed computation constructor 201 determines a collection of executions and processes associated with the user context. Depending on the type of a user context, various processes and executions may be performed. For example, playing a game may involve processes such as audio/visual presentation, search, etc. In step 505 the distributed computation constructor 201 breaks the execution context into smaller processes that can be executed independently and their combination may reconstruct the original execution context. The distributed computation constructor 201 receives the decomposed processes and generates computation closures equivalent of each process. Each closure is a standalone process that can be executed independently from the other closures. Following the definition of computation closures, distributed computation constructor 201 serializes the closures according to an information syntax format. By way of example, the serialization process may include identification of factors such as input, output, parameter exchange, hardware requirements that are required for proper execution of a process. The factors may be linked, attached or assigned to the closure to be further utilized for the execution. A serialized closure is ready for migration to the desired run-time environment. In one embodiment, the serialization process can also create a graph structure (e.g., an RDF graph) that represents the computation closure.

It is noted that steps of process 500 may be performed by components or modules located inside the distributed computation constructor 201, or located outside the distributed computation constructor 201 and having connectivity to the distributed computation constructor 201 via the communication network 105 or via the computation closures management infrastructure 103 or a combination thereof.

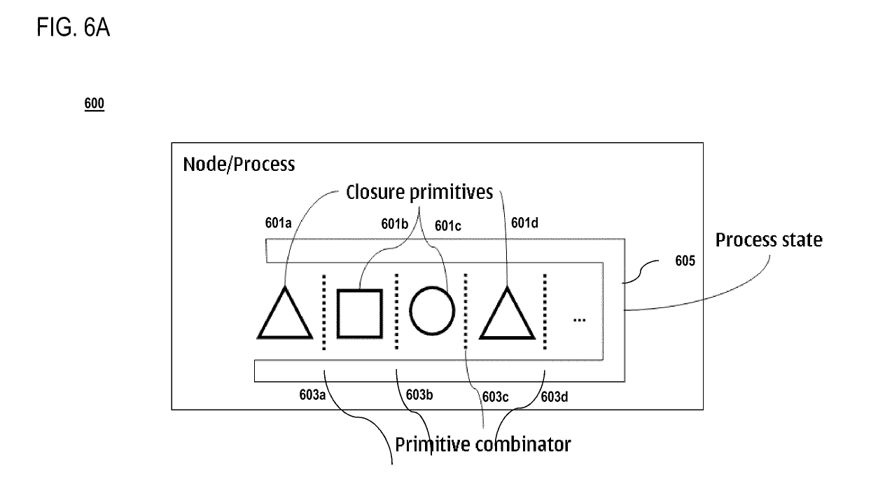

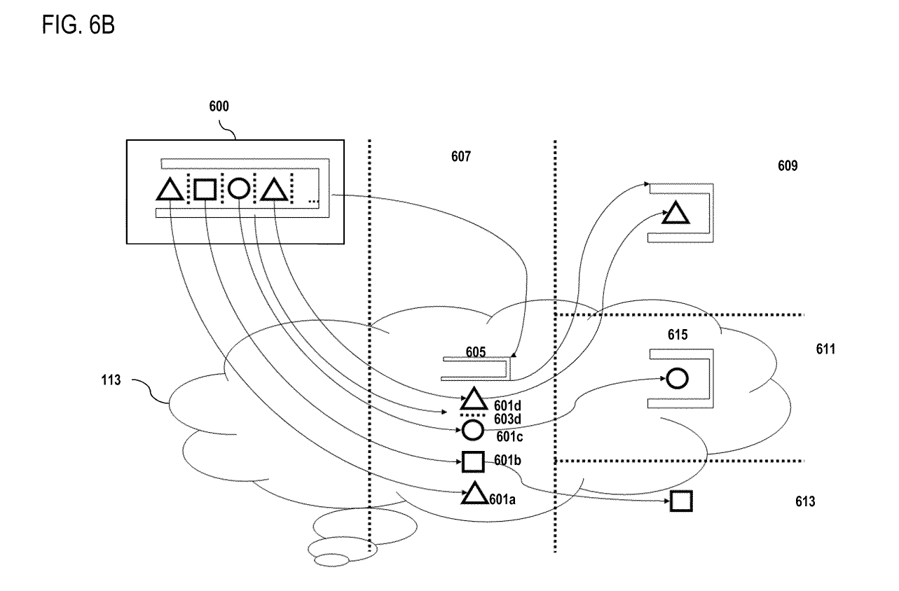

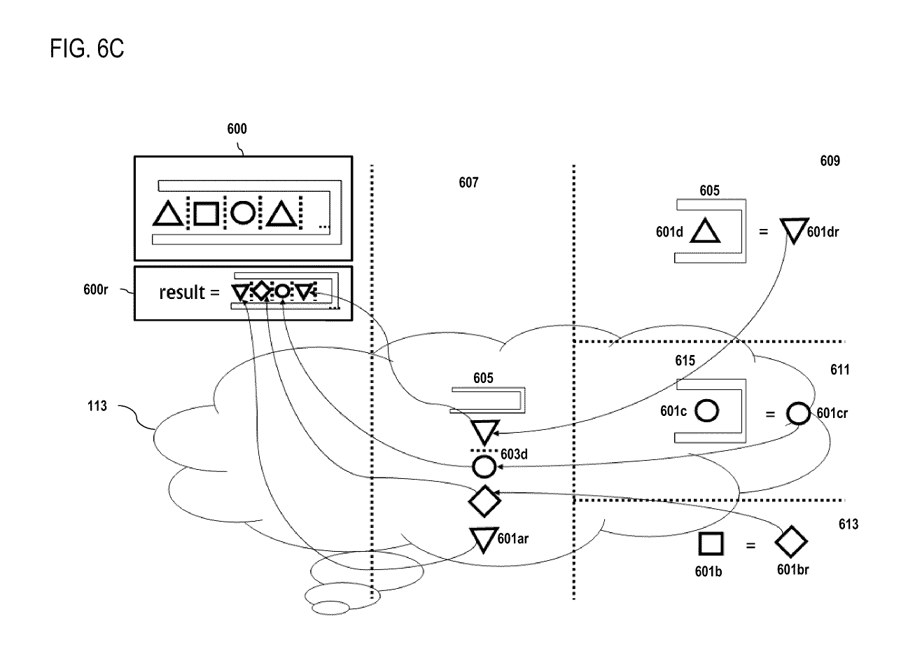

FIGS. 6A-6C are diagrams of computation distribution, according to various embodiments. FIG. 6A shows a process as a combination of primitive closures. Process 600 consists of closure primitives 601a-601d. The closure primitives 601a-601d are combined with each other into process 600 by combinators 603a-603d. The object 605 represents the execution requirements including process states under which the execution of closures 601a-601d combined by 603a-603d will result in the process 600.

FIG. 6B shows the decomposition of process 600. During the decomposition, closures 601a-601d, combinators 603a-603d (only 603a shown) and the process states 605 are migrated as independent components into, for instance, a virtual run-time environment 607 included in a smart space 113 associated with process 600. The independent closures 601a-601d from run-time environment 607 may be distributed into different run-time environments 609, 611 and 613 where they may be executed. As seen in FIG. 6B, the closure 601d and the process states 605 have been distributed to the run-time environment 609, the closure 601c has been distributed into the run-time environment 611 where a process states 615 already exists. The execution of closure 601c in environment 611 under the process states 615 may lead to accurate results only if the process states 615 include the process states 605. The verification as to whether process states 615 can be considered as an equivalent of process states 605 is determined by the distributed computation constructor 201 or a component associated with the distributed computation constructor 201 (not shown). Furthermore, the closure 601b has been distributed to the run-time environment 613 where the process states do not exist. Similarly, in this case the distributed computation constructor 201 or a component associated with the distributed computation constructor 201 may check and verify a correct closure distribution.

It is noted that the standalone property of computation closures shows that the closures are transitive, meaning that the results of execution of one or more processes from a closure will also be a member of the closure.

FIG. 6C shows the aggregation of the independent closures distributed in FIG. 6C into the result 600r of process 600. As seen in FIG. 6C, in the virtual runtime environment 609 the closure 601d is combined with the process states 605 and the result closure 601 dr is produced. Similarly process 601C is combined with the process states 615 in the run-time environment 611 and the result 601cr is produced. In environment 613, the closure 601b may be transformed utilizing the existing process states in the environment, and the result is closure 601br. The closure 601a (from FIG. 6B) has been combined with the process states 605 in the run-time environment 607, and the result 601ar has been produced. The resulting closures are sent back to the run-time environment 607 where the distributed computation constructor 201 or a component associated with the distributed computation constructor 201 (not shown) aggregates all the resulting closures into a process 600r to reconstruct an equivalent of process 600. Resulting process 600r may be executed by another UE or by any other processors associated with the user of the initial UE (where process 600 initiated) via the smart space 113.

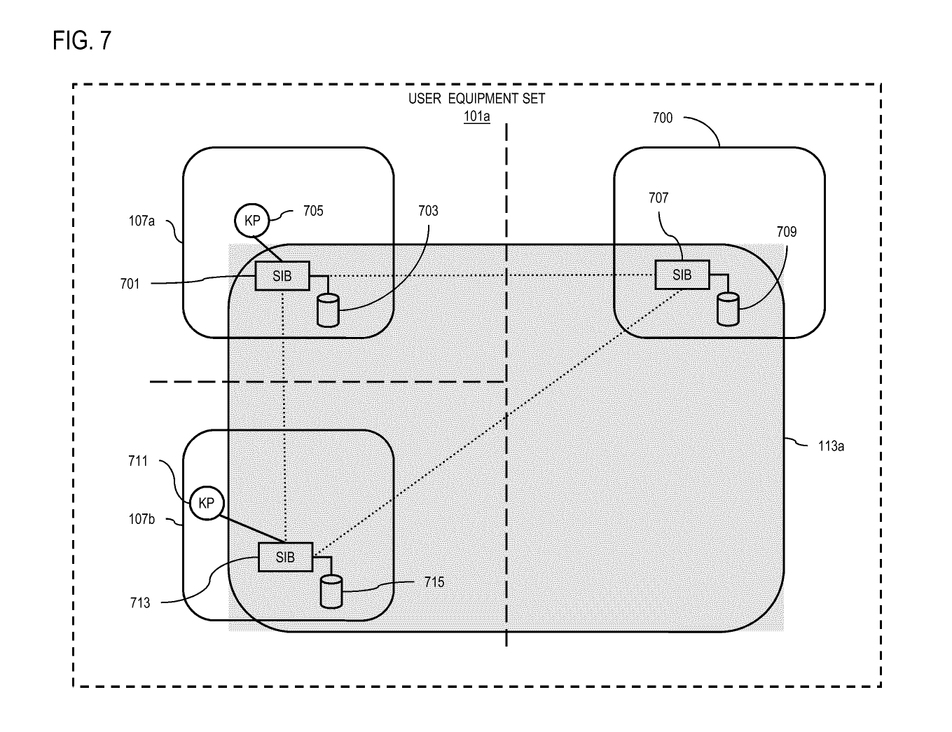

FIG. 7 is a diagram of user equipment set, according to one embodiment. As seen in FIG. 7, the user equipment set 101a consists of UEs 107a and 107b and another device 700 which may not be a user equipment, but a part of the smart space 113a for the user. The device 700 may for example be part of a server environment. The user may own a smart space set 113a which is distributed between devices 107a, 107b and 700. The smart space set 113a includes Semantic Information Brokers (SIB) 701 in UE 107a, the SIB 707 in device 700 and the SIB 713 in UE 107b. Additionally, each smart space in set 113a has knowledge processors (KPs) 705 in UE 107a and 711 in UE 107b. Furthermore, the information space may utilize storage components 703, 709 and 715 of the devices involved in the information space. The SIBs of information space set 115a-115j may communicate with each other (shown with dotted lines). Assuming that UEs 107a and 107b are located in a close proximity from each other (e.g. in an office) the user may desire to transmit processes that were initiated on one of the UEs to the other. For example, the user may start playing an online video on UE 107a, and realizing that the UE 107a does not have sufficient processing power or storage space for downloading and playing the video. The user may grab the element on the UI of the UE 107a representing the video and push it towards UE 107b. The user gesture may activate the migration process from UE 107a to UE 107b under supervision of the computation closures management infrastructure 103, and as a result the video is downloaded and played on UE 107b, while user is able to utilize UE 107a for other purposes (e.g. making phone calls, text messaging, etc.). The decomposition and aggregation of the sub-processes is performed by the distributed computation constructor 201 and the execution of migrated processes is performed by KP 711 under the supervision of the computation closures management infrastructure 103. Following the completion of the execution, the computation closures management infrastructure 103 may update the context of UE 107a to the state as if the video was played by UE 107a. Furthermore, the context of UE 107b may be reset to the state prior to process migration, meaning that processes that may have been halted for the execution of the migrated processes can be resumed.

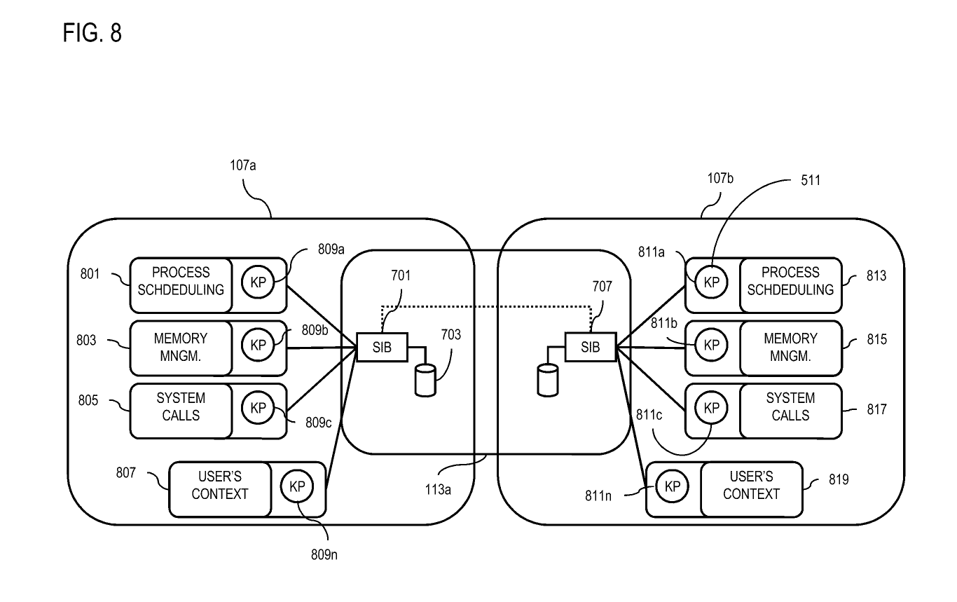

FIG. 8 is a diagram of process migration, according to one embodiment. Typically, during an information processing lifecycle, one or more execution contexts that may be represented in RDF form based on sub-graphs are stored by a SIB 701 of an information space 115a. The user context and execution context may result from execution of a program code of an application by a knowledge processor KP 809a-809n and stored in memory 703 of UE 107a which is utilized by SIB 701. If a KP 809a-809n of UE 107a detects that the UE 107b is attempting to communicate with UE 107a over a communications medium, UE 107a can share the user and execution contexts over a communications connection in the communications medium with UE 107b for continued or enhanced execution of an application by a KP 811a-811n in UE 107b. Following the completion of the process on UE 107b, the UE 107a may receive an alert from the SIB 701 indicating closing of the communication connection with (for example stationary wireless) UE 107b. In this case, UE 107a may receive updated user and execution contexts from the UE 107b over the communications connection so that the UE 107a can continue the execution of the application on a KP 809a-809n.

It is noted that a communications medium can be physical or logical/virtual, but all managed by the computation closures management infrastructure 103 as virtual run-time environment high-context information (information processing context is seen as snapshot in the form of sub-graph). The sharing of the user and execution contexts and reflective process execution of the application on KP 811a-811n of UE 107b is managed by the computation closures management infrastructure 103. The computation closures management infrastructure 103 shares and provides reasoning about user and execution contexts between UE 107a and UE 107b with SIBs 701 and 707. For example UE 107a may be a mobile wireless device and UE 107b may be a stationary wireless device.

The distributed computation constructor 201 enables decomposition and aggregation of user and execution context information and scheduling of the run-time environment. This enables changes to be made to one or more user contexts 807 and 819 and execution contexts (not shown). Changes to user and execution contexts may include starting, executing, scheduling, dispersing, and aggregating of information within the environment of the information space set 115a processes or tasks wrapped through KPs 809a-809n and 811a-811n or other KPs functionalities such as process scheduling 801 and 813, memory management 803 and 815, system calls 805 and 817, etc.

KPs 809a-809n and 811a-811n and their corresponding information in the form of RDF sub-graph dispersion and aggregation may be performed by selective recycling apparatus of the information space set 115a and/or the distribution. Selective recycling may be performed by the closure recycling and marshaling 411 driven by a recovery-conscious scheduler that may be part of the information space environment scheduler and supported by information provided by the computing environment processes/tasks scheduler 801 and 813. The user contexts 807 and 819 and the execution contexts (not shown) may be dynamically assigned and triggered and allocated according to a particular or operating system task management. It is noted that the terms KP and relevant information within SIB, represented as RDF sub-graph sets are abstract enough to be presented through other procedural aspects of the computing environment (e.g. a higher abstraction level).

In one embodiment, following the receipt of one or more user contexts 807 and 819 and additional execution contexts by UE 107b from UE 107a, and other relevant information over a communications medium, the UE 107b executes or shares the reflective state of the application by a KP 811a-811n. Upon completion of the process, the UE 107b may determine the information shared with SIB 707 through corresponding KP 811a-811n. This determination may result in closing a secure communication link with UE 107a. Prior to closing the communication connection, the UE 107b may share one or more user and execution contexts with UE 107a over the communications medium for continued execution of the application by KP 809a-809n in UE 107a. The sharing of the user and execution contexts and execution of the application on UE 107a is managed by the computation closures management infrastructure 103. Such virtual run-time environment enables shared user and execution context sessions between UE 107a and UE 107b.

In another embodiment, prior to closing of the communication connection, the UE 107b may share an initial portion of the updated user and execution context with UE 107a over a initial communication connection and share the remaining portion of the updated user and execution contexts with UE 107a over the last communication connection for continued execution of the application on UE 107a. The adaptive computing platform described enables granular information processing context migration capability for a computing device to enhance the processing power of the devices within the information space environment.

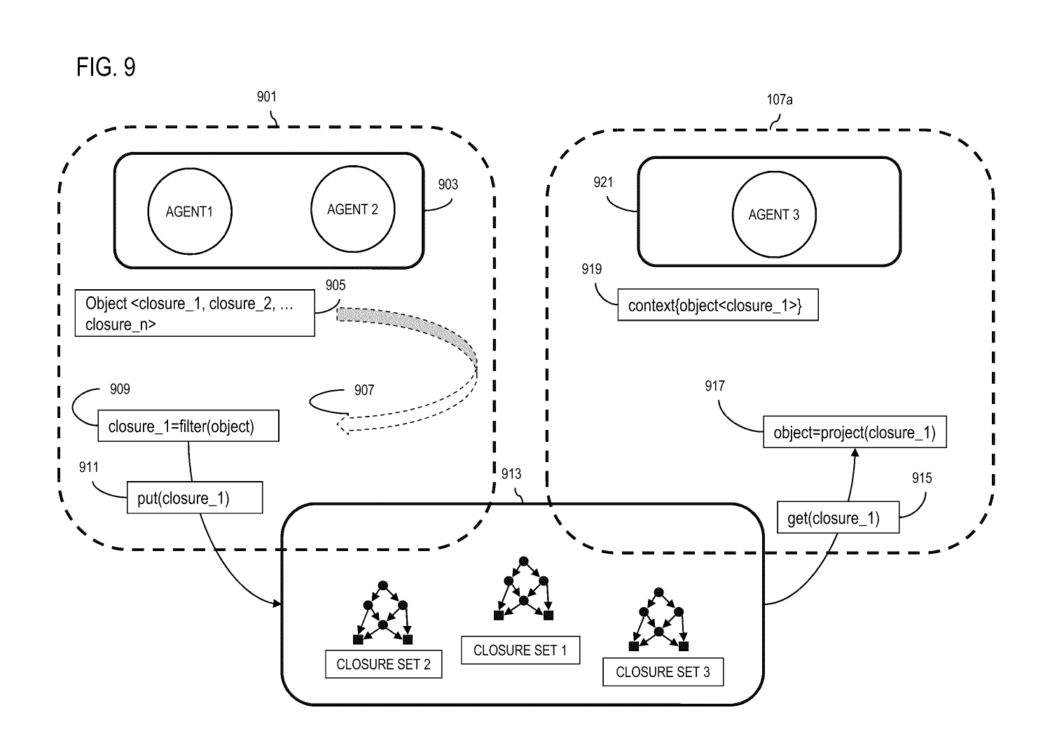

FIG. 9 is a diagram of process migration from a device to another device, according to one embodiment. In one embodiment, the backend device 901 may be a virtual run-time environment within the user's smart spaces 113a-113n or on one UE 107 associated with the user. The backend device 901 may include a user context 903 for every user equipment 107a-107i connected to the backend device 901. The user context 903 may be a copy of the user context 921 for each device 107a which is being migrated among devices. Agent1 and agent2 are processors that calculate and handle computation closures within the user context 903. The number of agents may be different in different devices based on their design, functionality, processing power, etc. Block 905 represents an Object as a set of computation closures, closure_1, closure_2, . . . , and closure_n, where each closure is a component of a larger process, for example, related to a service provided to the user by the user equipment 107a. The closures may be generated by a component of the distributed computation constructor 201 and each closure is a standalone process that can be executed independently from the other closures. In the example of FIG. 9, the filtering process 907 extracts closure_1 from the closure set Object via filtering the set (shown in block 909) by a component of the distributed computation constructor 201. The extracted closure_1 is added to a computation closure store 913 using the exemplary Put command 911.

In this example, assuming that the extracted computation closure, closure_1 is supposed to be executed on the user equipment 107a, the user equipment 107a extracts the computation closure closure_1 from the computation closure store 913 using the Get command 915.

In one embodiment, the decision of the equipment on which a computation closure is executed, may be made by a user by pushing, or flicking specific icons of the user interface associated with a process on one user equipment towards another user equipment (e.g. 107a). In another embodiment, the equipment executing a computation closure may be automatically assigned. The extracted closure_1 is projected into a closure with the user device context (process states) and the object 917 is produced. The block 919 represents the reconstruction of the closure into the initial context by a component of the distributed computation constructor 201. The aggregated context may then be executed in the run-time environment 921 of UE 107b by Agent3.

In another embodiment, the block 901 may be a user equipment and block 107a a backend device or both blocks 901 and 107a may be UEs. In this embodiment the decomposition and aggregation processes are similar to the above example with the difference that closure_1 is extracted from a process on the UE 901.

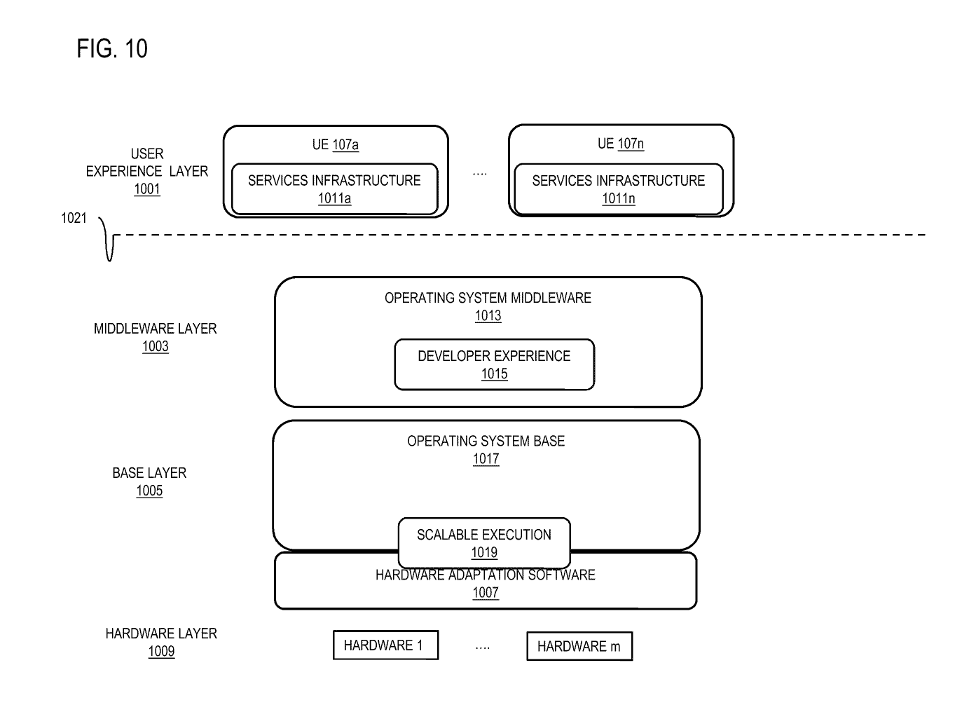

FIG. 10 is a diagram of alignment between layers of a system providing distributed computations, according to one embodiment. The system of FIG. 10 comprises main layers such as a user experience layer 1001, a middleware layer 1003, a base layer 1005 and a hardware layer 1009. The user experience layer 1001 is the tangible layer of the system to the user. This layer may include the UEs 107a-107n wherein each UE may include a service infrastructure 1011a-1011n. The service infrastructure comprises the services that the UE provide to the user such as voice, data, audio, video, and parameters and setups associated with the provided services.

The dotted line 1021 separates the user environment from the system environment which is invisible to the user. The middleware layer 1003 may include the operating system (e.g. MeeGo®, Symbian®, etc.) middleware 1013 and the developer experience 1015. The operating system middleware 1013 may include components such as Application Programming Interfaces (APIs) which are independent from the hardware and the usage model of the operating system, various toolkits such as operating system's native toolkits or application toolkits, additional operating system utilities, etc. The developer experience 1015 includes the programs and scripts produced by the developers and installed on top of the operating system for tailoring the system services to the specific needs of UEs 107a-107n. The base layer 1005 includes the operating system base 1017 which may include kernel and core services of the operation system. The operating system base 1017 communicates with the hardware layer 1009 via hardware adaptation software 1007. The hardware adaptation software 1007 interprets the messages and commands communicated between the operating system base 1017 and the machine code associated with the hardware devices hardware1, to hardware m. Still, an additional scalable execution component 1019 may be utilized in order to scale the functions of the operating system base 1017 with the hardware adaptation software 1007. The scalable execution 1019 provides compatibility between the operating system base 1017 and the hardware adaptation software 1007. The functionalities associated with computation distribution may be incorporated in various components of the system of FIG. 10 such as, for example, the developer experience 1015, the service infrastructure 1011a-1011n, etc.

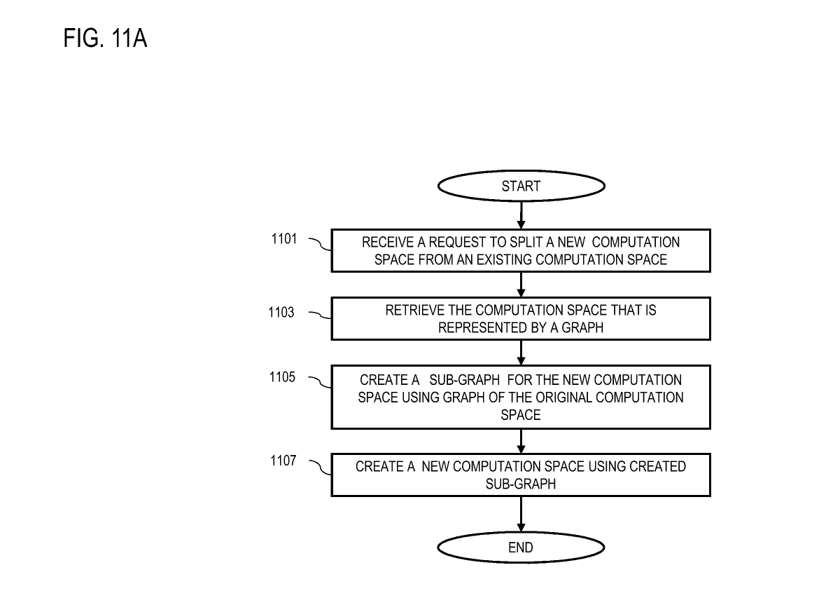

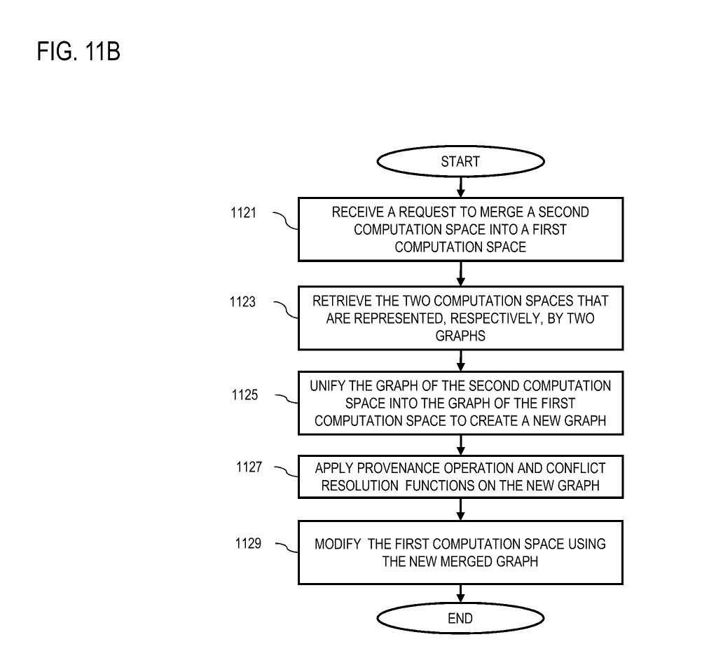

FIG. 11A is a flowchart of a process for applying a split operation on a computation space, according to one embodiment. A computation space 111a-111i (referred to here as n) can be split or partitioned into two computation spaces according to some partitioning criteria over the deductive closure Δₙ and rules ρₙ. For a partitioned computation space a, the partitioning function φ is defined such that the set of rules and computations content of a is enough to ensure that the partitioned deductive closure is met; an optimization of this is to find the minimal set of computations and rules to preserve the deductive closure. Thus split is defined as follows where n is an existing computation space and a is a new computation space.

$$split ( n , a , φ ) \to \{ \begin{matrix}( a , {φ}_{a} ( {I}_{n} ) , {φ}_{a} ( {ρ}_{n} ) ) \\ ( n , {I}_{n} , {ρ}_{n} )\end{matrix} \}$$

where

Δₐ=Δ(φₐ(Iₙ),φₐ(ρₙ))

The split module 205 receives, as in step 1101 of FIG. 11, a request to extract a new computation space from an existing computation space, wherein the new computation space is represented by a subgraph. In step 1103, the split module 205 of FIG. 2 retrieves the existing computation space that is represented by a graph. For the purposes of explanation, the split operation is explained with respect to partitioning of the computations into two computation spaces where one computation space is extracted from an original computation space while the original computation space remains intact. However, the process can be easily extended to represent splitting of a computation space into a plurality of computation spaces. As per step 1105, a new subgraph for the new computation space is created from the original graph and in step 1107 a new computation space is created using the new graph.

It is noted that the steps of these processes may be performed in any order, as well as combined or separated in a different manner.

FIG. 11B is a flowchart of a process for applying a merge operation on a computation space, according to one embodiment. According to one embodiment, the process of merge operation related to merge module 203 of FIG. 2 is described in FIG. 11B. Given two existing computation spaces a and n, the merge operation in a purely monotonic environment returns the computation spaces a merged with n and the unchanged n such that the computation sets contained within computation spaces a and n (graphs and the rule sets) join together in a:

$$merge ( a , n ) \to \{ \begin{matrix}( a , {I}_{a} ⋃ {I}_{n} , {ρ}_{a} ⋃ {ρ}_{n} ) \\ ( n , {I}_{n} , {ρ}_{n} )\end{matrix} \}$$

Monotonicity of logical implication is a property of many logic systems and it states that the hypotheses of any derived fact may be freely extended with additional assumptions. Any true statement in a logic with this property continues to be true, even after adding new axioms. Logics with this property may be called monotonic. The monotonocity of logical rule sets ρₐ and ρₙ enable the simple unification of the two rule sets to provide a proper rule set for the new merged computation space. It means that adding a formula to a theory never produces a reduction of its set of consequences. Intuitively, monotonicity indicates that learning a new piece of knowledge cannot reduce the set of what is known.

The operation of merge does not necessarily remove the computation space n after it is merged into a, however this feature could be created as an addition to the operation:

mergeD(a,n)→{(a,Iₐ∪Iₙ,ρₐ∪ρₙ)}

However for merge operation an issue may arise when two particular nodes in the information graphs have differing URIs while represent the same element of information and therefore a mechanism for unifying two graphs at the information level of the computations is required. The graph provenance problem with respect to information graphs is an open problem and various solutions for it have been suggested. For example, L. Ding, et al. in “Tracking rdf graph provenance using rdf molecules” in the Proceedings of the Fourth International Semantic Web Conference, 2005; L. Moreau, et al. in “The open provenance model”, Technical report, University of Southampton, 2007; and L. Moreau et al. editors, “Provenance and Annotation of Data”, International Provenance and Annotation Workshop (IPAW), 2006, LNCS 4145, Springer Verlag, May 2006 (which are incorporated herein by reference in their entireties); provide the basis for such mechanisms, where a generic operation I is defined that represents all the mechanisms bound. A monotonic logic cannot handle various reasoning tasks such as reasoning by default (where consequences may be derived only because of lack of evidence of the contrary), abductive reasoning (where consequences are only deduced as most likely explanations) and some important approaches to reasoning about knowledge (the ignorance of a consequence must be removed when the consequence becomes known) and similarly belief revision (new knowledge may contradict old beliefs). Therefore, the logical rule sets of special computation spaces are not limited to monotonic logics and non-monotonic systems may be used. This could lead to another issue when the logic of the rule sets ρₐ and ρₙ are non-monotonic, meaning that their consequences are not monotonic; and therefore the pairs of rules could conflict after unification. Various mechanisms for rule conflict resolution are known, for example in the book by P. H. Winston, titled “Artificial Intelligence”, Addison Wesley Longman Publishing Co. Inc., 2004 (which is incorporated herein by reference in its entirety). Here, a generic function δ is defined that represents the conflict resolution mechanisms.

Considering the two functions γ and δ for resolving provenance and monotonicity issues respectively, a new definition for merge operation is presented:

$$merge ( a , n ) \to \{ \begin{matrix}( a , ϒ ( {I}_{a} ⋃ {I}_{n} ) , δ ( {ρ}_{a} , {ρ}_{n} ) ) \\ ( n , {I}_{n} , {ρ}_{n} )\end{matrix} \}$$

Under this and the other operations, given two computation spaces a and b, the following holds:

(Iₐ∪I_{b})⊂γ(Iₐ∪I_{b})

However, because of the non-monotonicity of the rule sets, this is not necessarily true under the deductive closure. Therefore, the following formula is not always true:

Δ(Iₐ∪I_{b})⊂Δ(γ(Iₐ∪I_{b}))

The flowchart of FIG. 11B shows the merge process by merge module 203 form FIG. 2. As seen in FIG. 11B, in step 1121, a request is received for merging a first existing computation space into a second existing computation space. In step 1123, the two computation spaces that need to be merged are retrieved by merge module 203. For the purposes of explanation, the merge operation is explained with respect to joining a second computation spaces into a first computation space while the second computation space is preserved; however, the process can be easily extended to represent joining multiple computation spaces into one computation space. In step 1125, the merge module 203 unifies graphs of the two computation spaces into the first graph, and creates a new graph for the merged computation space. In step 1127, the merge module 203 applies a provenance operation (γ) and a conflict resolution function (δ) to the new graph for the identical nodes to be removed and a new rule set is created. In step 1129, the merge module 203 modifies the first computation space using the new graph and the new rule set.

It is noted that the steps of these processes may be performed in any order, as well as combined or separated in a different manner.

As explained before, one of the building blocks of a computation space is a graph of computations nominally conforming to, for example, Resource Description Framework (RDF) semantics. It is possible to have larger grained structures within RDF graphs based on the ontologies that represent these graphs. An ontology is a formal representation of a set of concepts within a domain and the relationships between those concepts. It is used to reason about the properties of that domain, and may be used to define the domain. In theory, an ontology is a “formal, explicit specification of a shared conceptualization”. An ontology provides a shared vocabulary, which can be used to model a domain, that is, the type of objects and/or concepts that exist, and their properties and relations.

RDF graphs can be combined in a unified graph as well as decomposed into their constituent subgraph. However, in order to avoid information loss, the logical relations between graph nodes need to be preserved during the process or the nodes need to be functionally grounded. The presence of Blank Nodes (BNodes) complicates RDF graph decomposition since BNodes do not come with universally unique identifiers. A BNode is a node that is not a URI reference or a literal. In the RDF abstract syntax, a BNode is just a unique node that can be used in one or more RDF statements, but has no intrinsic name. BNodes from different RDF graphs are assumed different by default; however there is no way to recognize whether two BNodes represent the same or different things. Some BNodes could be functionally grounded given a background ontology stating that some properties are instances of web ontology language OWL Inverse Functional Property (IFP) or OWL Functional Property (FP). The definition to build a three-fold categorical partition on RDF nodes can be extended; this is fully described in Ding et al. in “Tracking RDF Graph Provenance using RDF Molecules” (Technical report, 2005, Proceedings of the Fourth International Semantic Web Conference, 2005); which is incorporated herein by reference in its entirety.

Ding et al. defines the concept of molecules of an RDF graph according to some ontology whereas named graphs are defined as a particular region of a graph. Like the molecules in natural science, the molecules of an RDF graph are the finest components into which the graph can be decomposed without loss of information. Molecules are not fixed at creation time; instead, they are the decomposition results of a given RDF graph. If an RDF graph is free of BNodes, each triple constitutes a molecule; otherwise, triples are grouped into molecules according to the background ontology and the decomposition algorithm. The described approaches for computation closure management consider molecular structures for RDF graphs.

An RDF graph decomposition as defined by Ding el al. consists of three elements (W, d, m), the background ontology W, the decompose operation d(G, W) which breaks an RDF graph G into a set of subgraphs Ĝ={G₁, G₂, . . . , Gₙ} using W, and the merge operation m(Ĝ, W) which combines all elements in Ĝ into the a unified RDF graph G′ using W. In addition, a decomposition should be lossless such that for any RDF graph G: G=m(d(G, W), W). When the elements in Ĝ are disjoint, Ĝ is called a partition of G.

Given a graph under deductive closure Δ and set of ontologies W, a decomposition as a lattice of molecules ordered by graph inclusion can be constructed in the manner of Ding et al. This is denoted as:

d_{⊂}(n,W)

Neither the top nor the bottom elements representing the empty molecule or the complete graph necessarily exist; although the latter exists if the set of ontologies specified completely covers the graph.

Given a graph and a partitioning function φ, the graph can be divided into two parts: a subgraph S that satisfies φ and the complement of S denoted as C. However, there will be individual nodes in the graph representing RDF triples that are part of both subgraphs. These nodes that are in the intersection of two subgraphs are said to be boundary nodes.

$$boundryNodes ( n , φ ) \to ( \begin{matrix}nodes ( φ ( {Δ}_{n} ) ) \\ ⋃ \\ nodes ( {Δ}_{n} - φ ( {Δ}_{n} ) )\end{matrix} ) \qquad ( 1 )$$

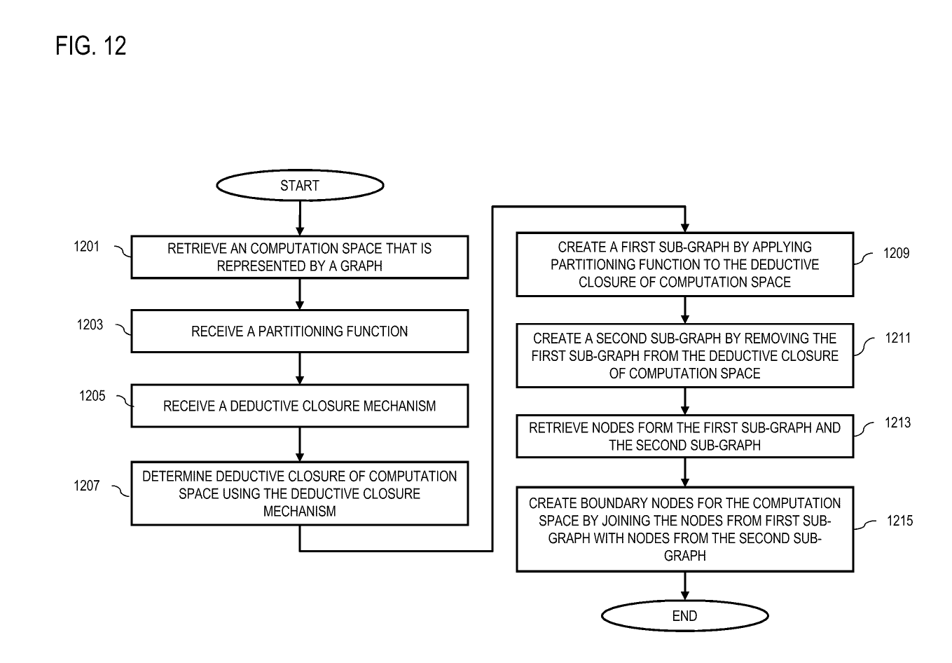

FIG. 12 is a flowchart of a process for defining a boundary for a computation space, according to one embodiment. The process of boundary definition is conducted by the computation closures management infrastructure 103. In steps 1201-1205 of FIG. 12, a computation space, a partitioning function, and a deductive closure mechanism are received as inputs to the boundary determination function of computation closures management infrastructure 103. In step 1207, the boundary determination function determines the deductive closure of the computation space. In step 1209, the partitioning function is applied to the deductive closure and as a result a first graph is created. In step 1211, the result graph of step 1209 is removed from the deductive closer determined in step 1207 and as a result a second graph is created. Next, step 1213 retrieves the nodes from the first and the second graphs resulted from steps 1209 and 1211. The outcome of the execution of step 1213 will be the first row and the second row on the right hand side of formula (1) above, respectively. In step 1215, the set of boundary nodes for the input computation space is generated by joining the two sets of nodes retrieved.

The process of splitting and projecting computation spaces generally use more semantically ‘complete’ structures, i.e., molecules, rather than triples. This minimizes the loss of information at the ‘edges’ of the graph caused by indiscriminated breaking of arcs between nodes.

For each boundary node, a molecule from d_{⊂} which contains that boundary node can be selected. Generally, this is guided by some heuristics but one can filter the lattice of molecules to favor a particular sub-lattice; for example, the least lower bound of d_{⊂}(n,w)−Ø for molecules of a certain size. This boundary can be used in two ways, firstly it can be used to create a history; and secondly, to extend the set generated by the partitioning function φ. For example the definition of split operation can be extended as follows:

$$split B ( n , a , φ ) \to \{ \begin{matrix}( a , φ ( {I}_{n} ) ⋃ B , φ ( {ρ}_{n} ) , ) \\ ( n , {I}_{n} , {ρ}_{n} , {P}_{n} )\end{matrix} \}$$

where B is the boundary set computed according to some heuristics with respect to the requirements of that split.

In one embodiment the notion of storing histories or ‘memories’ of activities of a computation space and how this can be used to extend the computations that are returned as answers to a request is introduced. When a computation space is split or projected, the information can be recorded about how newly created computation space(s) are related to the original computation space. This requires an additional element in the definition of computation space which is the set of histories indexed by name. The extended definition of a computation space including set of histories H is as follows:

S→(n,I,ρ,P,H)

When a computation space is split or projected, the boundary can be calculated using formula (1) and the boundary information can then be stored in the split computation space's history:

$$split B H ( n , a , φ ) \to \{ \begin{matrix}( a , φ ( {I}_{n} ) ⋃ B , φ ( {ρ}_{n} ) , {β}_{a} ) \\ ( n , {I}_{n} , {ρ}_{n} , {P}_{n} , {H}_{n} ⋃ {β}_{n} )\end{matrix} \} \qquad ( 2 )$$

where B is the boundary set and βₐ and βₙ are similar to B with different heuristics tailored towards the information necessary for preservation of the history.

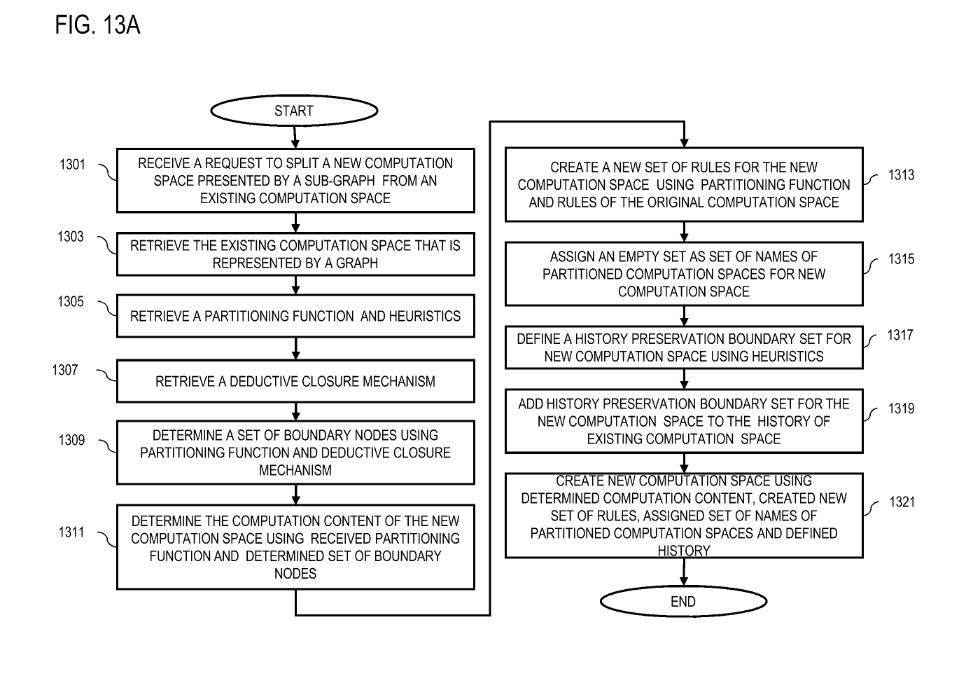

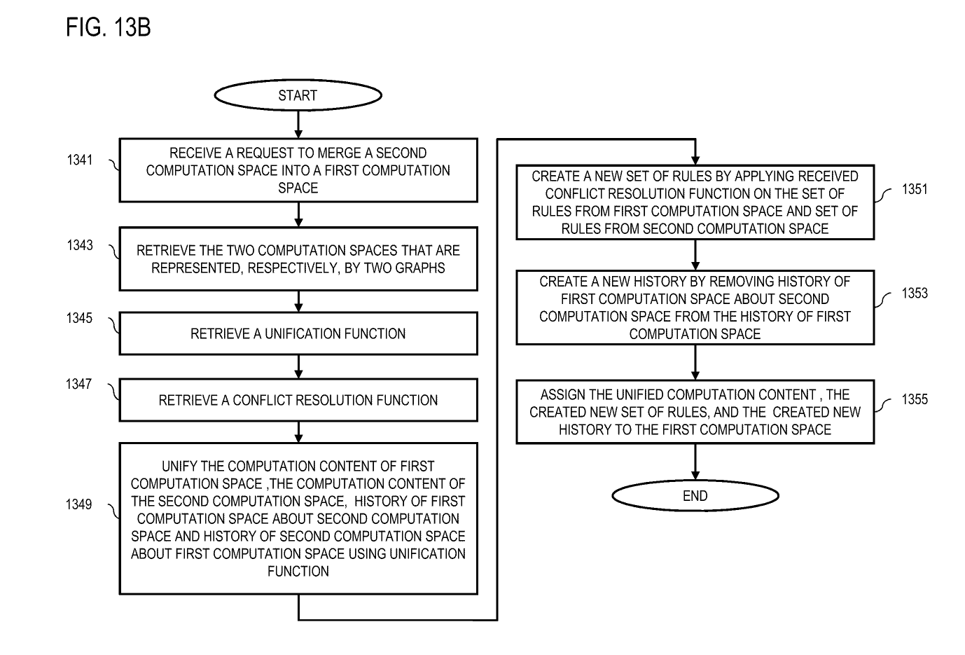

FIG. 13A is a flowchart of a process for applying a split operation on a computation space considering boundary and history information, according to one embodiment. The steps of flowchart of FIG. 13A are explained with regards to formula (2) above. In step 1301, the split module 205 receives a request for splitting of computation space n into computation space a. In step 1303, the split module 205 retrieves the initial computation space n that needs to be split is retrieved. The partitioning function φ and the heuristics are retrieved by the split module 205 in step 1305. In step 1307, the split module 205 retrieves the deductive closure mechanism. Step 1309 includes the process of boundary determination for computation space n as explained in detail in FIG. 8. In step 1311, the split module 205 determines the content of new computation space a using the partitioning function and the boundary calculated in previous step as φ (Iₙ)_{∪}B. In step 1313, the split module 205 calculates a set of rules for computation space a by applying the partitioning function φ on set of rules ρₙ of computation space n. Since a is a new computation space created by the split operation, the list of names of projected computation spaces from a is not relevant to the operation and is set to an empty set Ø in step 1315. In step 1317, the split module 205 defines a history preservation boundary set βₐ for computation space a, and in step 1319, the split module 205 adds the boundary set βₙ to the history of initial computation space n in phrase H_{n∪}βₙ. Up to this point, all the elements required for creation of new computation space a are derived. Therefore, in step 1321, the split module 205 creates the new computation space a as a partition of computation space n using the derived elements.

Under the merge operation, the history information can be utilized to enhance the core information content I of a computation space and thus provide additional information for the unification function γ:

$$merge H ( a , n ) \to \{ \begin{matrix}( \begin{matrix}a , ϒ ( {I}_{a} ⋃ {I}_{n} ⋃ {H}_{a} [ n ] ⋃ {H}_{n} [ a ] ) , \\ δ ( {ρ}_{a} , {ρ}_{n} ) , {P}_{a} , {H}_{n} - \{ {H}_{n} [ a ] \}\end{matrix} ) \\ ( n , {I}_{n} , {ρ}_{n} , {P}_{n} , {H}_{n} )\end{matrix} \} \qquad ( 3 )$$

Another variation of this operation could be re-computing the new boundary between a and n for the computation space being merged.

FIG. 13B is a flowchart of a process for applying a merge operation on a computation space considering boundary and history information, according to one embodiment. The steps of flowchart of FIG. 13B are explained with regards to formula (3) above. In step 1341, a request for merging computation spaces a and n is received by the merge module 203. In step 1343, the merge module 203 retrieves the two existing computation spaces a and n that need to be merged. In step 1345, the merge module 203 retrieves the unification function γ and in step 1347 the merge module 203 retrieves the conflict resolution function δ. In step 1349, the merge module 203 applies the unification function on the information content of the two computation spaces and a unified content is created. However, the content of the merged computation space is not complete until the history that each initial computation space has about the other is incorporated into the information content. Therefore, the history of each computation space about the other is unified with the information content in step 1349 of FIG. 13B as shown by phrase I_{a∪}I_{n∪}Hₐ[n]_{∪}Hₙ[a] in formula (3). In step 1351, the merge module 203 creates a new set of rule by applying the conflict resolution function to the sets of rules of the two initial computation spaces. This is applied by phrase δ(ρₐ,ρₙ) in formula (3). Conflicts may arise from the fact that the two initial computation spaces may include rules that could lead to contradicting results for the same query. For example, one computation space may have a rule that “If A is true then B is true” while the other computation space may include a rule stating “If A is true then B is false”. After the two computation spaces are merged, existence of these rules may lead to conflicts in query results. Application of function δ resolves contradiction in the rules. In step 1353, the merge module 203 creates a new history for the merged computation space by removing the history of first computation space about second computation space from the history of first computation space as seen in phrase Hₙ−{Hₙ[a]} in formula (3). Thus, after the merge operation, the initial computation space a is replaced by the newly created merged computation space, thereby the history about the old a need not be retained any longer. Up to this point, all the elements required for creation of new computation space a are derived. In step 1355, the merge module 203 assigns the created elements such as information content, rules and history to the first computation space (computation space a) as the result of merge. It is noted that the list representing names of computation spaces partitioned from a (Pₐ) remains unchanged. Furthermore, the computation space n will remain unchanged as well.

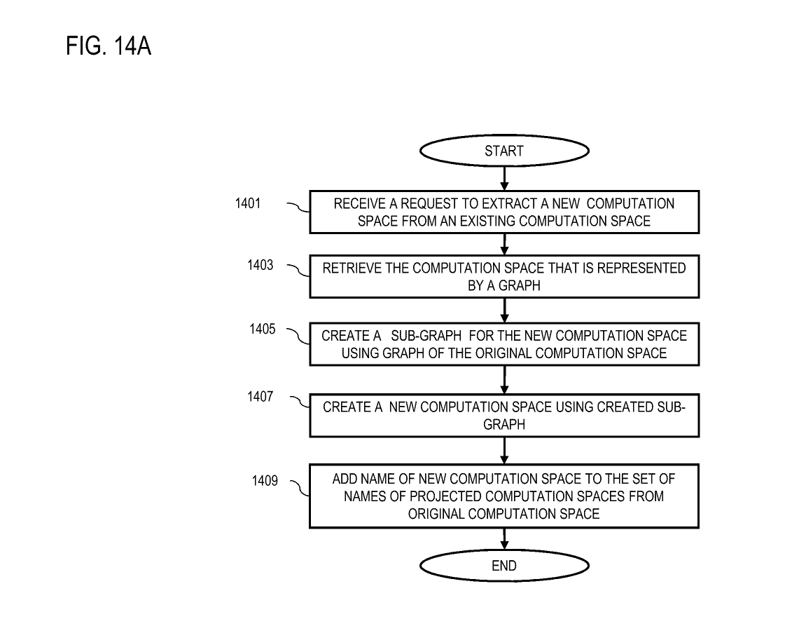

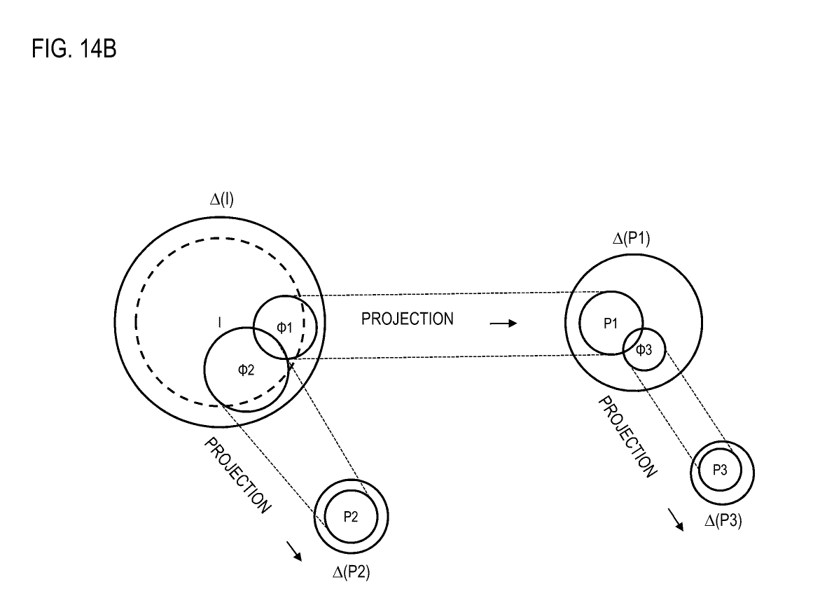

FIGS. 14A-14B are a flowchart and a diagram, respectively, of a process for applying projection operation on a computation space, according to one embodiment. In one embodiment, the projection process related to projection module 207 from FIG. 2 is described. The process of projection is similar to the one of split with the difference that in projection the system keeps track of the projected computation spaces using an additional parameter such as P to be added to the definition of computation space where P is the list of names of projected computation spaces. Therefore, the definition of a computation space is modified as follows:

S→(n,I,ρ,P)

In order to conduct projection from computation space n, the name of projected computation space (e.g., p) and a partitioning function (e.g., analogous to function described with respect to the split operation) are used. Projection is thus defined analogously to split where n is an existing computation space and p a new computation space:

$$project ( n , p , φ ) \to \{ \begin{matrix}( p , φ ( {I}_{n} ) , φ ( {ρ}_{n} ) , ) \\ ( n , I , ρ , P ⋃ \{ p \} )\end{matrix} \} \qquad ( 4 )$$

where

Δₚ=Δ(φ(Iₙ),φ(ρₙ)) (5)

As seen in formula (4) the newly created computation space p has no projection history and therefore its list of names of projected computation spaces is an empty set Ø. However, with each projection p created, the newly created computation space p is added to the list P of names of projected computation spaces of original computation space n, shown as P∪{p} in formula (4). Also as seen in formula (5), the deductive closure of the new computation space p is created by application of partitioning function φ on the content I and rule set ρ of the original computation space n.

As seen in FIG. 14A, the projection module 207 receives, as in step 1401, a request to extract a new computation space from an existing computation space, wherein the new computation space is represented by a subgraph. In step 1403, the projection module 207 retrieves the computation space that is represented by a graph. For the purposes of explanation, the projection operation is explained with respect to partitioning the information into two computation spaces where one computation space is extracted from an original computation space while the original computation space remains intact. However, the process can be easily extended to represent splitting of a computation space into a plurality of computation spaces. As per step 1405, a new subgraph for the new computation space is created from the original graph, and in step 1407, a new computation space is created using the new graph. Finally, in step 1409, the name of the newly created computation space is added to the list of projected computation spaces from the existing computation space. In one embodiment, the list of projected computation spaces is recorded as a parameter (P) of the projection function described below with respect to FIG. 14B.

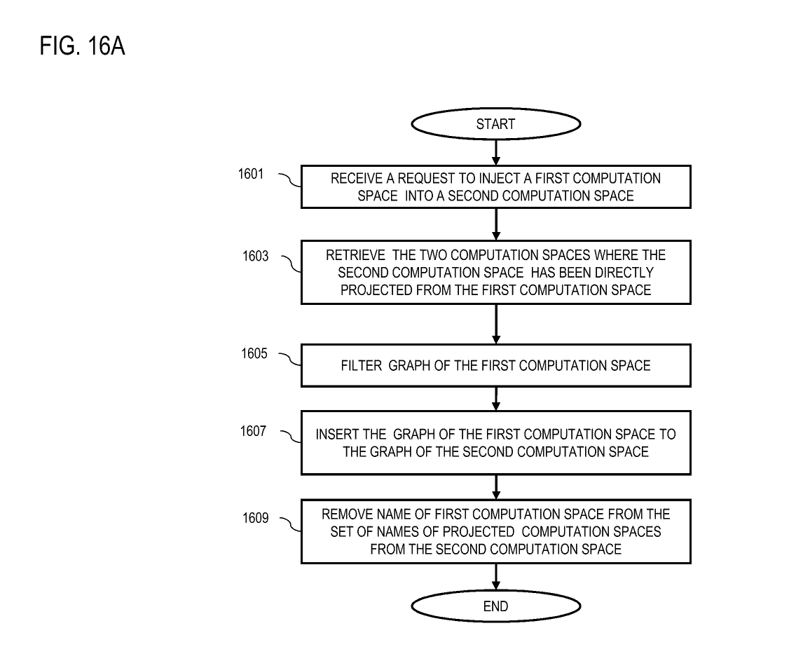

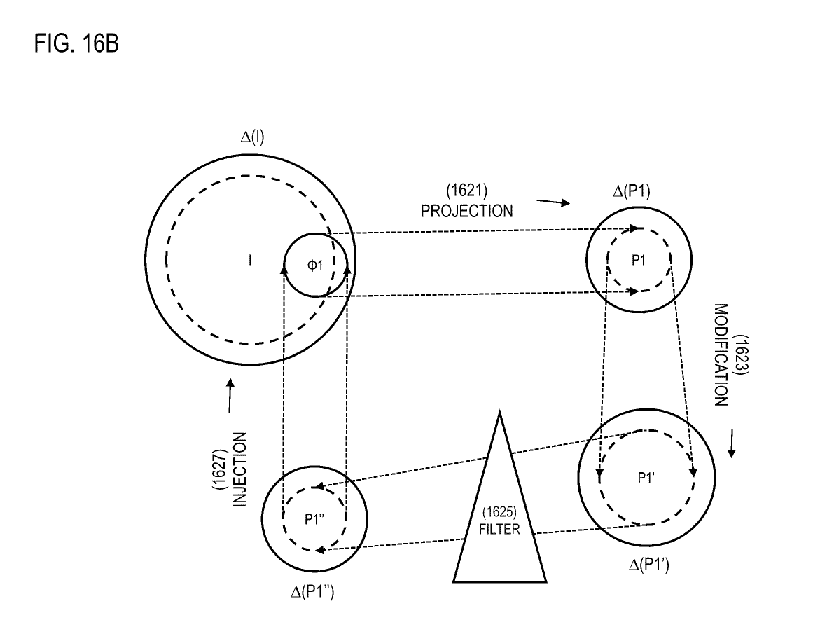

In another embodiment, the projection module 207 uses the list of projected computation spaces to maintain a link between the projected computation space and the computation space from which it was projected. This link, for instance, enables the return of information (e.g., using the injection operation described with respect to FIG. 16A) from the projected computation space to the original computation space. In certain embodiments, content may be projected recursively (e.g., a content from a projected content is then projected to yet another projected content, and so on). Accordingly, the return of content may also occur recursively by incorporating changes from each subsequently projected computation space. It is contemplated that the return of content from such recursively projected computation spaces may occur in the order the content was projected or in any other order. If the return of content is performed in any order, changes to the projected content may be reconciled based on, for instance, the date and time of the change or any other criteria (e.g., person or entity making a change, priority assigned to the change, etc.). Although the link is described herein with respect to the list of projected spaces, it is contemplated that, in addition or alternatively, the link may use any mechanism to relate or link the two computation spaces (e.g., a history parameter, another computation space to specify the link, or the like).

It is noted that the steps of these processes may be performed in any order, as well as combined or separated in a different manner.

As visualized in FIG. 14B, the nature of projection is such that a tree of projected computation spaces can be formed, and thus no circularity is possible. In FIG. 14B, I and P1 are contents of two computation spaces with deductive closures Δ(I) and Δ(P1) respectively; and φ1, φ2, and φ3 are projection functions. According to formula (4), application of functions φ1 and φ2 on information content I result in creation of new information contents P1 and P2 where P1 is φ1(Iₙ) and P2 is φ2(Iₙ). According to formula (4) application of the deductive closure mechanism Δ on the newly created information content and rules sets, would create deductive closures Δ(P1) and Δ(P2) for newly created computation spaces. (The rule sets are not shown in the diagram of FIG. 14B). Furthermore, a third projection function φ3 is applied on computation space P1—that is created by projection itself—and a new computation space P3 with deductive closure Δ(P3) is created which is a second level projection from the original computation space n. As seen in FIG. 14B and in formula (4), multiple levels of projection and many projections from a single computation space are possible while in each step the basic computation space that the projection is applied on is kept unchanged and the list of projected computation spaces is preserved in the fourth parameter of a computation space (P).

The partitioning function φ is a predefined function which operates based on the preferences of the network management, information providers, computation space owners, and/or security and privacy criteria (e.g., predefined criteria) in the architecture of the system.

With adding the fourth parameter to the definition of computation space for use in the projection operation, the operations on computation spaces that were described before (e.g., with respect to the split operation) is modified by adding the fourth parameter to the computation spaces involved. For example, the insert operation of formula (A) will now be:

insert(n,g)→(n,I∪g,ρ,P)

The projection operation provides the insert operation with a new feature:

insert(n,g)→(n,I∪g,ρ,insert(P,g))

This means that application of operation insert over a projected computation space will propagate over the transitive closure of projected computation spaces. In other words, the projection module 206 can propagate, after projection, any modifications to the content of the original computation space related to the projected computation space into the content of the projected computation space. Similarly, this feature applies to other operations such as remove and update.

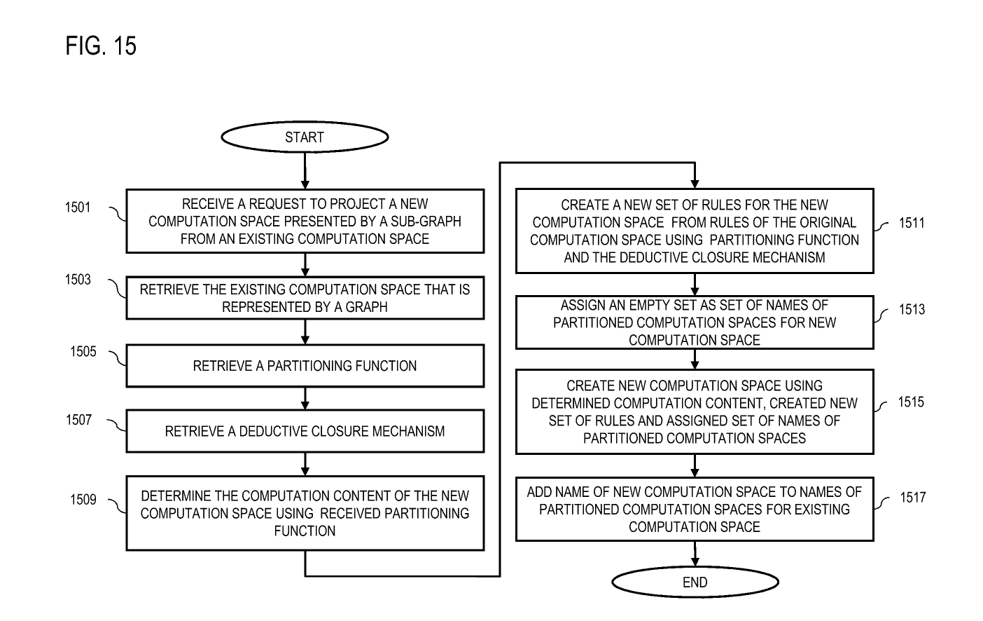

FIG. 15 is a flowchart of a process for applying a projection operation on a computation space using an equation, according to one embodiment. In one embodiment, the process of FIG. 15 is implemented in the projection module 207 and is explained with regards to formula (4) above. In step 1501, the projection module 207 receives a request for projection from an existing computation space n into computation space p. In step 1503, the projection module 207 retrieves the initial computation space n that is to be projected. In step 1505, the projection module 207 retrieves a partitioning function φ. By way of example, the partitioning function is previously defined by network managers, content owners, etc. Similarly, in step 1507, the deductive closure mechanism Δ, which is also predefined by the network managers, content owners, etc., is retrieved. In step 1509, the projection module 207 calculates the content of new computation space p by applying the partitioning function on the information content of the initial computation space as φ(Iₙ). In step 1511, the projection module 207 determines a set of rules for computation space p by applying the partitioning function φ and the deductive closure mechanism Δ on the set of rules ρₙ of computation space n. Because p is a new computation space and does not have any other computation spaces projected from it, the list of names of projected computation spaces from p is set to an empty set Ø in step 1513. Up to this point, all the elements required for creation of new computation space p are derived. Therefore, in step 1515, the projection module 207 creates the new computation space p as a projection of computation space n using the derived elements. In step 1517, the name or other identifier of the newly created computation space p is added to the list of names of computation spaces projected from computation space n. This is represented by the phrase P_{∪}{p} in formula (4). For example, adding the name of the new computation space p to the list of spaces projected from n maintains a link between the two spaces which enables changes to space p to be injected back into space n, if required by the content owner.

It is noted that propagation of updates from the existing computation space into the projected new computation space is performed such that any addition, deletion or modification of information in the existing space is reflected into the new projected space, if necessary.

FIGS. 16A-16B are a flowcharts and a diagram, respectively, of a process for applying an injection operation on a computation space, according to one embodiment. The injection process is related to injection module 209 from FIG. 2. In various situations, it might be necessary to return (or inject) the contents of a projected computation space i back to the original computation space n that it was projected from. However, the projected computation space may have been updated since the projection took place and might have different content. Therefore, a filter φ is needed in order to remove any inserted content that is not required to be injected back into the original computation space. The content removed by the filter may include, for instance, a functionality added to the projected computation space that was not part of the original functions. The injection also induces a merge of content over any computation spaces that were further projected from the projected computation space. It is noted that for an injection operation to apply, both computation spaces i and n must exist:

$$inject ( i , n , φ ) \to \{ \begin{matrix}fail \text{:} & i ∈ {P}_{n} \\ ( n , {I}_{n} ⋃ {I}_{i} , {ρ}_{n} , P - \{ i \} ) \text{:} & i ∉ {P}_{n} ⋀ {P}_{i} = \\ ( n , {I}_{n} ⋃ merge ( {P}_{i} , i , φ ) , {ρ}_{n} , P ) \text{:} & i ∉ {P}_{n} ⋀ {P}_{i} \neq \end{matrix} \qquad ( 6 )$$

As seen in formula (6) above, if computation space i does not exist in list P of projected computation spaces from computation space n, the injection operation will fail. This is because a computation space not projected from computation space n cannot be injected into n. However, if i already belongs to the list of projections from n, and there are no other computation spaces projected from i, the content of i is combined into the content of n and name of space i is removed from the list of projections from n. In another case scenario where there are other computation spaces projected from i (list of projections from i is not empty), in order to inject computation space i into computation space n, the projections from i are merged or injected back into i recursively over the closure of projected spaces of i. Merging the computation spaces projected from spaces i back into i, using the filtering function φ prevents any undesired updates in projected computation spaces that took place after projection, from being injected into space n.

For example, assuming that a content owner has stored parts (sub-processes) of a larger process on a home computer. The content owner may want to create a duplicate from one or more parts of the computation into a notebook computer in order to be able to continue computations while away from home. The projection operation can create a new computation space including only the desired parts while maintaining the link to keep track of the projection. At the end of the day, the content owner may want to inject updates back into the original computation except updates on a certain process. The updates may include, for example, run-time parameters, process setups, etc. In this case, the injection operation using a filtering function can ensure exclusion of the undesired updates and inject the rest of the updates from the notebook into the original content on the home computer.

Moreover, as previously discussed, updated information from projected computation spaces may be returned to the spaces i in the order of projection or in any order. Multiple changes or conflicting changes may then be returned and the changes resolved at the spaces i using any rule or criteria. Referring to the example above, for instance, the content owner may have used two separate notebook computers containing two separate projections of the same content. The content owner may set a rule defining how updates on one notebook computer will be handled in relation to changes on the other notebook computer. For example, a rule may state that when there are conflicting or overlapping changes, the more recent change controls. Alternatively, a rule may state that changes on one notebook computer always take precedence over changes on another notebook computer.

The flowchart of FIG. 16A shows the injection process by injection module 209 from FIG. 2. As seen in FIG. 16A, in step 1601, the injection module 209 receives a request for injecting a first existing computation space into a second existing computation space. In step 1603 the injection module 209 retrieves the two computation spaces that one is to be injected into the other. For the purposes of explanation, the injection operation is explained with respect to joining an already projected second computation space into a first computation space it was projected from. However, the process can be easily extended to represent joining a plurality of already projected computation spaces into one computation space from which the spaces all were projected. In step 1605, the injection module 209 filters the graph of the first computation space using a filtering function φ, described above in formula (6), for the undesired modifications made since the projection of the first computation space from the second computation space to be removed. In step 1607, the filtered graph of the first computation space is inserted into the graph of the second computation space by the injection module 209. Next, in step 1609, the injection module 209 removes the first computation space from the list of computation spaces projected from the second computation space. In one embodiment, the removal of the first computation space from the list breaks the projection relationship between the two computation spaces. As a result, after completion of the injection operation, the first computation space cannot be reinjected into the second computation space.

In one embodiment, the injection process operates on computation spaces i that are immediate projections from n. Also after the injection the computation space i and any other computation spaces projected from i will no longer be addressable by computation space n and will be considered as non-existent from the point of view of n. Therefore, as previously stated, it is also implied that once a computation space is injected into another computation space it cannot be injected a second time.

As visualized in FIG. 16B, I and P1 are contents of two computation spaces with deductive closures Δ(I) and Δ(P1) respectively; and φ1 is a projection function. According to formula (4), application of functions φ1 on information content I results in creation of new information content P1 where P1 is φ1(Iₙ). According to formula (5), application of the deductive closure mechanism Δ on the newly created content and rules set, would create deductive closures Δ(P1) for the newly created computation space. (The rule set is not shown in the diagram of FIG. 16B). After projection (step 1621) in FIG. 16B is applied, during modification (1623), the information content P1 could be modified into P1′. In the process of injecting P1 back into I, some of the modifications on P1 can be removed. Accordingly, in step 1625 of FIG. 16B, a filter is applied to P1′ and as a result P1′ is converted to a new computation space P1″ to remove some of the modifications. In one embodiment, the filtering function is based on predefined criteria. These criteria (e.g., incompatible content, etc.) may be defined by the service provider, user, network operator, content owner, and/or the like. Next, in step (1627) of FIG. 16B, the injection operation of formula (6) is applied to the new computation space P1″ to inject P1″ into I.

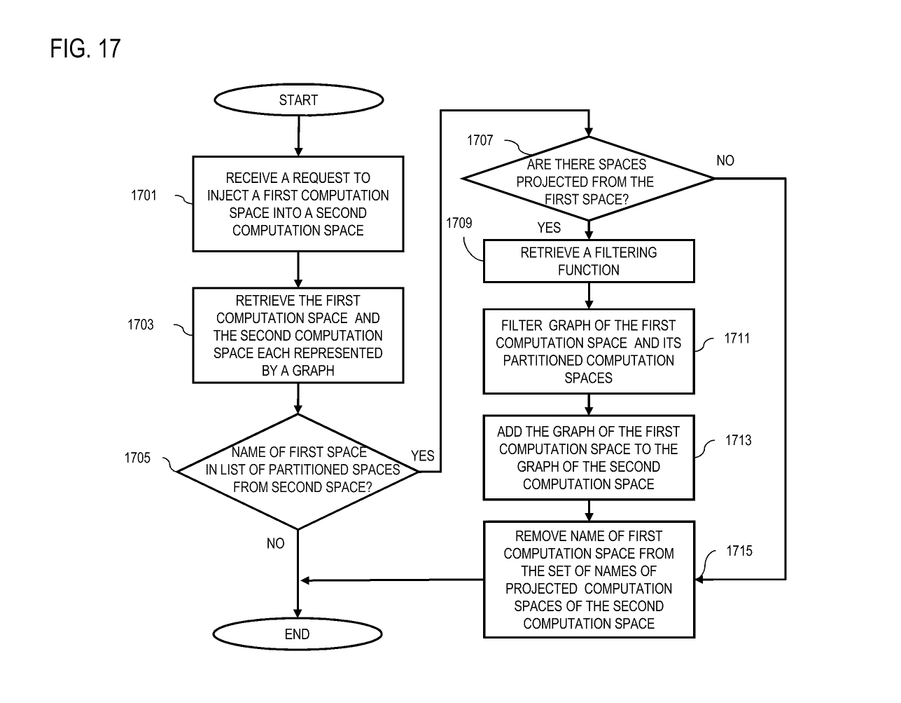

FIG. 17 is a flowchart of a process for applying injection operation on a computation space using an equation, according to one embodiment. The steps of flowchart of FIG. 17 are explained with respect to formula (6) above. In step 1701, a request for injection of a first computation space (i) into a second computation space (n) is received by the injection module 209. In step 1701, the injection module 209 retrieves the two existing computation spaces i and n. Injection can occur if computation space i has been previously projected from computation space n. The injection module 209 then, per step 1705, checks whether this condition holds. If the condition does not hold (i∈Pₙ in formula (6)), the operation is not applied, and the process fails. Otherwise, if the condition holds (i∉Pₙ in formula (6)), in step 1707, the injection module 209 determines whether there are computation spaces that have been projected from space i. If such a projected space from space i does not exist, per step 1713 the content of the computation space i is added into the content of the computation space n and in step 1715 name of the computation space i is removed from the list of projected spaces from computation space n.

Otherwise, if projected spaces from i exist, these projections can be added back into i so that any desired changes that have been made to the content after i was projected from n can be added to i before i is injected into n. For example in the example given before for a process being projected by a user, the user may first project one process from the home computer, then project one sub-process from that process, and apply modifications on the sub-process. When the user decides to inject the process into the home computer, the injection module 209 checks whether the initially projected process has been projected again and therefore before the process is injected back into the home computer the modifications on the sub-process are added to the process. In step 1709, the injection module 209 retrieves a predefined filtering function. In step 1711, the injection module 209 applies the filtering function on computation space i and its projections. Application of the filtering function updates i to a version of i that includes any content from computation spaces projected there from.

In addition, the filter φ is applied on computation space i for any undesired (e.g., based on predefined criteria) modifications on computation space i performed after it was projected from n to be removed. For example, the user may want to ignore any inserted parameters in the process that have been inserted after a certain time, but add the modifications before that time. The filtering function φ could be predetermined in the system architecture, defined based on network administration regulations or defined by content owners. Therefore, while the process can be automated, the fact that whether or not updated content is to be injected into the original computation space is considered to be part of any surrounding architecture and logic. In step 1713, the filtered content of the computation space i is added into the content of computation space n. Finally, in step 1715, the name or other identifiers of the computation space i is removed from the list of projected computation spaces from the computation space n. This is because computation space i has been injected back into computation space n and therefore computation space i will be considered as nonexistent from the perspective of computation space n. By removing the names of one computation space from the list of computation spaces projected from another computation space, the link between the two computation spaces is removed. In other words, computation space i and any subsequently projected computation spaces from computation space i are no longer addressable from space n.

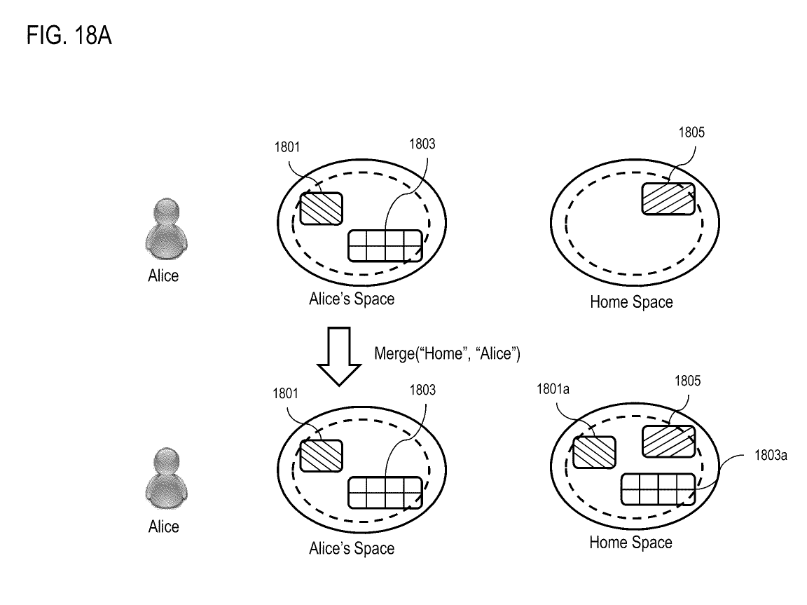

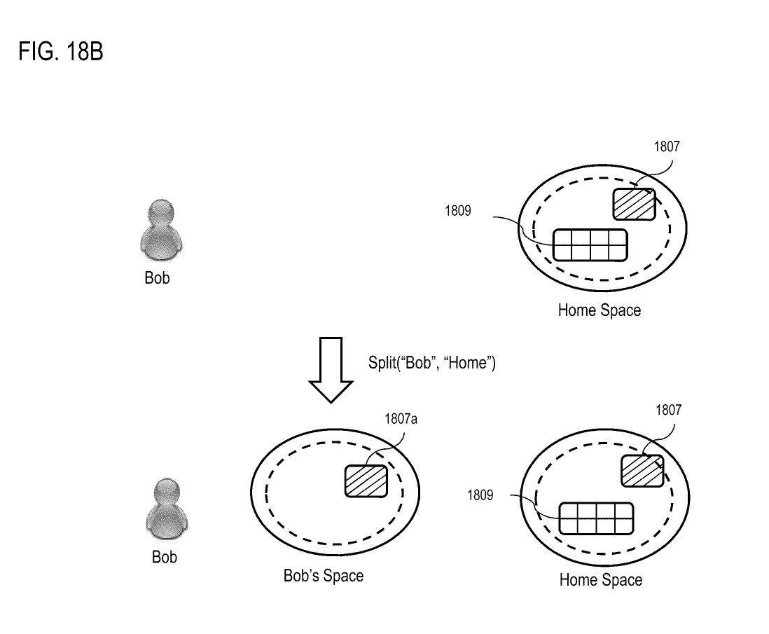

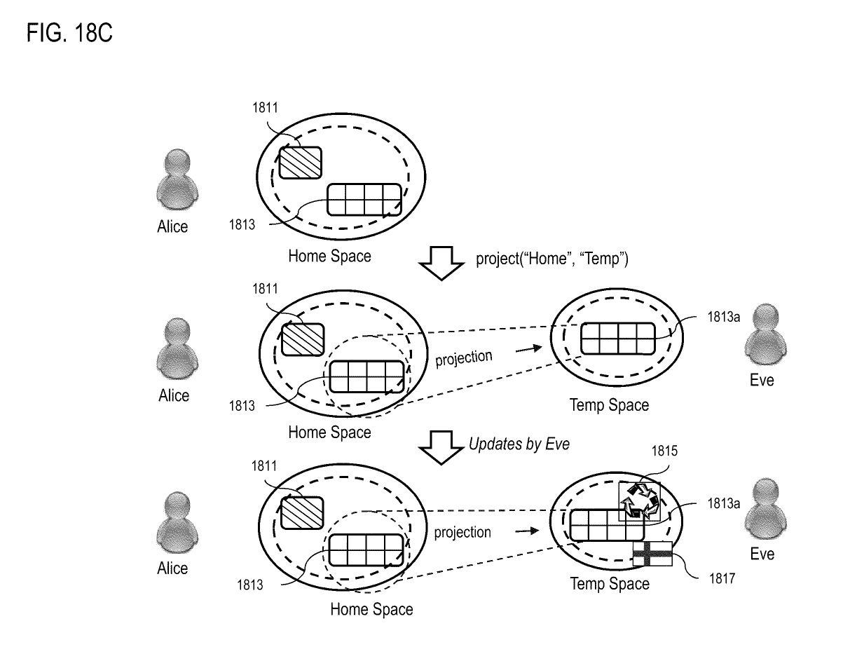

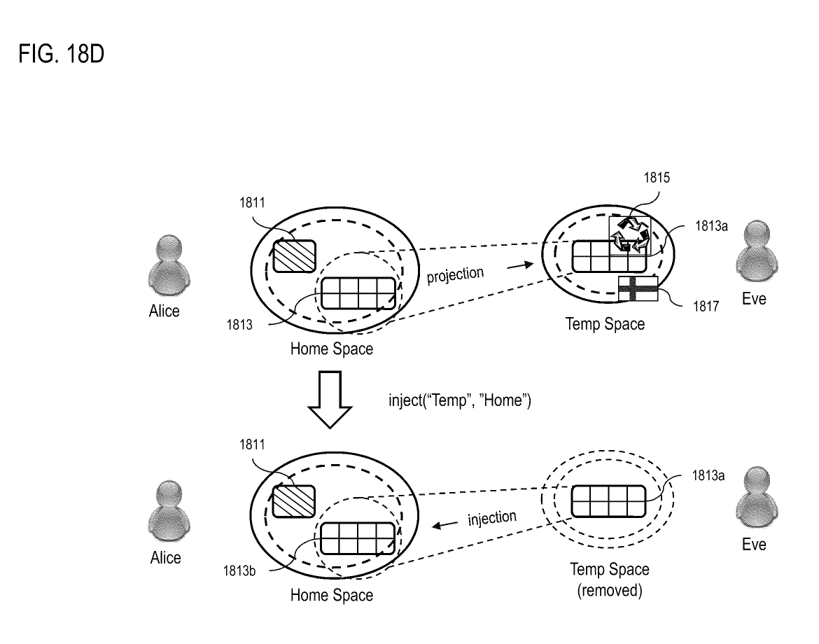

FIGS. 18A-18D are diagrams of example use cases for applying a split, merge, projection, and injection operation, respectively, on a computation space, according to various embodiments. These use cases involves an assumption that the agents/applications executing on the users' devices have access to all the content in the spaces they are connected to at all times. In other words, the computation spaces in the examples are ubiquitous in nature. FIGS. 18A and 18B present basic operations, while FIGS. 18C and 18D present extended scenarios utilizing historical information.

Some simple use cases for merge and split operations are based around copying and ‘taking away’ or ‘borrowing’ content. By way of example, two users, Alice and Bob, have their own computation spaces while they have a home-space in which they share and store their content (e.g. information, processes, etc.). During the day, Alice and Bob collect (e.g. download) content such as applications, media players, etc. When they return home they can merge their local spaces' content with home's the larger combined computation space. As seen in FIG. 18A, Alice has content 1801 and 1803 in her computation space, and home's computation space contains content 1805. After Alice runs merge operation copying her computation space into home's computation space, her computation space remains unchanged, but home-space now includes content 1801a (a copy of 1801) and 1803a (a copy of 1803), while it also maintains the content 1805 it already had.

Similarly in the scenario depicted in FIG. 18B, Bob may need to extract content from home-space and add it to his own computation space. Bob may already have a computation space or may be creating his computation space for the first time. If Bob already has a personal computation space then the operation of FIG. 18B involves the following steps. First, the process splits content from the home-space into a new temporary computation space. Subsequently, this computation space is merged with Bob's computation space. The temporary computation space can then be removed. In certain implementations, the combined application of “split-from-old” and “merge-with-existing” operation would appear as a single, atomic operation.

In FIG. 18B, a split operation is applied on home-space, for example, to extract Bob's preferred media player 1807. As shown in FIG. 18B, a copy of content 1807 is added to Bob's computation space as 1807a (or Bob's computation space is being created with filtered contents from the home-space) while home-space maintains its contents 1807 and 1809.

Another example is considered in FIG. 18C, which depicts a situation where, for example, Alice wishes to share an application 1813 from the home-space with her friend Eve. Given that Alice may not necessarily wish to give Eve access to other content 1811 in her (and Bob's) home-space, she can project out a filtered selection of content 1813 as 1813a to a temporary computation space for Eve to access. As seen in FIG. 18C, Eve can now interact with the temporary computation space, while Alice can interact with the home-space. Propagation of Alice's updates into projected temporary computation space continues while both users are interacting with the computation spaces. In this way, if Alice adds, deletes or modifies content 1813, Eve will see the changes in 1813a. However, Eve's updates are not necessarily automatically injected back to home-space. As seen, Eve has added content 1815 and 1817 to the temporary computation space and this information has not been injected in the home-space. While this could be automated, the basic operations discussed here need not take this into consideration and the injection of updated content into the original computation space is considered to be part of any surrounding architecture and logic.

FIG. 18D depicts yet another example where the temporary computation space provided to Eve in FIG. 18C is being injected back with filtering to the home-space. In FIG. 18D, content 1813b is equivalent of 1813 with the changes applied by Eve on 1813a filtered out. In the meantime, to preserve the temporary computation space, Eve might enact a split and merge similar to what described for Bob in FIG. 18B and transfer the information from temporary computation space into her own computation space. This of course will bring up the notion of data ownership. Since Eve is not the owner of shared content 1813a she may not be allowed to have them stored in her personal computation space. However, issues such as security implications are considered to be dealt with at the implementation phase as part of the system architecture.

The above approaches, in certain embodiments, advantageously provide efficient data processing, while minimizing use of system resources (e.g., bandwidth, and processing). That is, users and devices can issue requests, which can be answered expeditiously because of the management of the computation space. In this manner, the requesting user or device need not expend more resources and effort in locating desired content.

The processes described herein for providing operations for manipulation of distributed computations may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

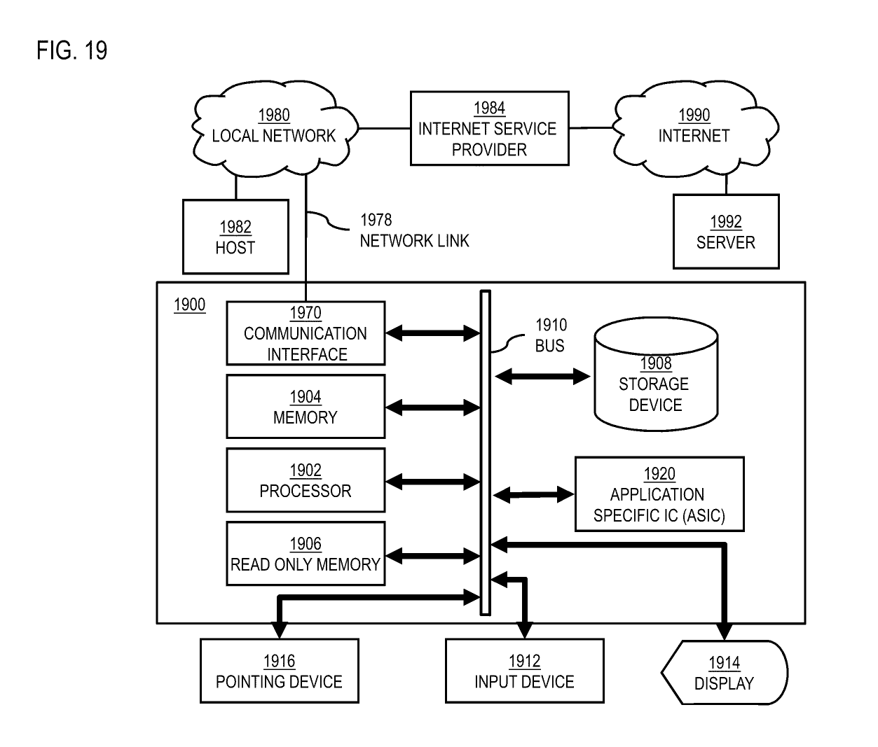

FIG. 19 illustrates a computer system 1900 upon which an embodiment of the invention may be implemented. Although computer system 1900 is depicted with respect to a particular device or equipment, it is contemplated that other devices or equipment (e.g., network elements, servers, etc.) within FIG. 19 can deploy the illustrated hardware and components of system 1900. Computer system 1900 is programmed (e.g., via computer program code or instructions) to provide operations for manipulation of distributed computations as described herein and includes a communication mechanism such as a bus 1910 for passing information between other internal and external components of the computer system 1900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1900, or a portion thereof, constitutes a means for performing one or more steps of providing operations for manipulation of distributed computations.

A bus 1910 includes one or more parallel conductors of information so that information is transferred quickly among devices coupled to the bus 1910. One or more processors 1902 for processing information are coupled with the bus 1910.

A processor (or multiple processors) 1902 performs a set of operations on information as specified by computer program code related to providing operations for manipulation of distributed computations. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1910 and placing information on the bus 1910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1900 also includes a memory 1904 coupled to bus 1910. The memory 1904, such as a random access memory (RAM) or other dynamic storage device, stores information including processor instructions for providing operations for manipulation of distributed computations. Dynamic memory allows information stored therein to be changed by the computer system 1900. RAM allows a unit of information stored at a location called a memory address to be stored and retrieved independently of information at neighboring addresses. The memory 1904 is also used by the processor 1902 to store temporary values during execution of processor instructions. The computer system 1900 also includes a read only memory (ROM) 1906 or other static storage device coupled to the bus 1910 for storing static information, including instructions, that is not changed by the computer system 1900. Some memory is composed of volatile storage that loses the information stored thereon when power is lost. Also coupled to bus 1910 is a non-volatile (persistent) storage device 1908, such as a magnetic disk, optical disk or flash card, for storing information, including instructions, that persists even when the computer system 1900 is turned off or otherwise loses power.

Information, including instructions for providing operations for manipulation of distributed computations, is provided to the bus 1910 for use by the processor from an external input device 1912, such as a keyboard containing alphanumeric keys operated by a human user, or a sensor. A sensor detects conditions in its vicinity and transforms those detections into physical expression compatible with the measurable phenomenon used to represent information in computer system 1900. Other external devices coupled to bus 1910, used primarily for interacting with humans, include a display device 1914, such as a cathode ray tube (CRT) or a liquid crystal display (LCD), or plasma screen or printer for presenting text or images, and a pointing device 1916, such as a mouse or a trackball or cursor direction keys, or motion sensor, for controlling a position of a small cursor image presented on the display 1914 and issuing commands associated with graphical elements presented on the display 1914. In some embodiments, for example, in embodiments in which the computer system 1900 performs all functions automatically without human input, one or more of external input device 1912, display device 1914 and pointing device 1916 is omitted.

In the illustrated embodiment, special purpose hardware, such as an application specific integrated circuit (ASIC) 1920, is coupled to bus 1910. The special purpose hardware is configured to perform operations not performed by processor 1902 quickly enough for special purposes. Examples of application specific ICs include graphics accelerator cards for generating images for display 1914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1900 also includes one or more instances of a communications interface 1970 coupled to bus 1910. Communication interface 1970 provides a one-way or two-way communication coupling to a variety of external devices that operate with their own processors, such as printers, scanners and external disks. In general the coupling is with a network link 1978 that is connected to a local network 1980 to which a variety of external devices with their own processors are connected. For example, communication interface 1970 may be a parallel port or a serial port or a universal serial bus (USB) port on a personal computer. In some embodiments, communications interface 1970 is an integrated services digital network (ISDN) card or a digital subscriber line (DSL) card or a telephone modem that provides an information communication connection to a corresponding type of telephone line. In some embodiments, a communication interface 1970 is a cable modem that converts signals on bus 1910 into signals for a communication connection over a coaxial cable or into optical signals for a communication connection over a fiber optic cable. As another example, communications interface 1970 may be a local area network (LAN) card to provide a data communication connection to a compatible LAN, such as Ethernet. Wireless links may also be implemented. For wireless links, the communications interface 1970 sends or receives or both sends and receives electrical, acoustic or electromagnetic signals, including infrared and optical signals, that carry information streams, such as digital data. For example, in wireless handheld devices, such as mobile telephones like cell phones, the communications interface 1970 includes a radio band electromagnetic transmitter and receiver called a radio transceiver. In certain embodiments, the communications interface 1970 enables connection to the communication network 105 for providing operations for manipulation of distributed computations to the UE set 101.

The term “computer-readable medium” as used herein refers to any medium that participates in providing information to processor 1902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1908. Volatile media include, for example, dynamic memory 1904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1920.

Network link 1978 typically provides information communication using transmission media through one or more networks to other devices that use or process the information. For example, network link 1978 may provide a connection through local network 1980 to a host computer 1982 or to equipment 1984 operated by an Internet Service Provider (ISP). ISP equipment 1984 in turn provides data communication services through the public, world-wide packet-switching communication network of networks now commonly referred to as the Internet 1990.

A computer called a server host 1992 connected to the Internet hosts a process that provides a service in response to information received over the Internet. For example, server host 1992 hosts a process that provides information representing video data for presentation at display 1914. It is contemplated that the components of system 1900 can be deployed in various configurations within other computer systems, e.g., host 1982 and server 1992.

At least some embodiments of the invention are related to the use of computer system 1900 for implementing some or all of the techniques described herein. According to one embodiment of the invention, those techniques are performed by computer system 1900 in response to processor 1902 executing one or more sequences of one or more processor instructions contained in memory 1904. Such instructions, also called computer instructions, software and program code, may be read into memory 1904 from another computer-readable medium such as storage device 1908 or network link 1978. Execution of the sequences of instructions contained in memory 1904 causes processor 1902 to perform one or more of the method steps described herein. In alternative embodiments, hardware, such as ASIC 1920, may be used in place of or in combination with software to implement the invention. Thus, embodiments of the invention are not limited to any specific combination of hardware and software, unless otherwise explicitly stated herein.

The signals transmitted over network link 1978 and other networks through communications interface 1970, carry information to and from computer system 1900. Computer system 1900 can send and receive information, including program code, through the networks 1980, 1990 among others, through network link 1978 and communications interface 1970. In an example using the Internet 1990, a server host 1992 transmits program code for a particular application, requested by a message sent from computer 1900, through Internet 1990, ISP equipment 1984, local network 1980 and communications interface 1970. The received code may be executed by processor 1902 as it is received, or may be stored in memory 1904 or in storage device 1908 or other non-volatile storage for later execution, or both. In this manner, computer system 1900 may obtain application program code in the form of signals on a carrier wave.

Various forms of computer readable media may be involved in carrying one or more sequence of instructions or data or both to processor 1902 for execution. For example, instructions and data may initially be carried on a magnetic disk of a remote computer such as host 1982. The remote computer loads the instructions and data into its dynamic memory and sends the instructions and data over a telephone line using a modem. A modem local to the computer system 1900 receives the instructions and data on a telephone line and uses an infra-red transmitter to convert the instructions and data to a signal on an infra-red carrier wave serving as the network link 1978. An infrared detector serving as communications interface 1970 receives the instructions and data carried in the infrared signal and places information representing the instructions and data onto bus 1910. Bus 1910 carries the information to memory 1904 from which processor 1902 retrieves and executes the instructions using some of the data sent with the instructions. The instructions and data received in memory 1904 may optionally be stored on storage device 1908, either before or after execution by the processor 1902.

FIG. 20 illustrates a chip set or chip 2000 upon which an embodiment of the invention may be implemented. Chip set 2000 is programmed to provide operations for manipulation of distributed computations as described herein and includes, for instance, the processor and memory components described with respect to FIG. 19 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 2000 can be implemented in a single chip. It is further contemplated that in certain embodiments the chip set or chip 2000 can be implemented as a single “system on a chip.” It is further contemplated that in certain embodiments a separate ASIC would not be used, for example, and that all relevant functions as disclosed herein would be performed by a processor or processors. Chip set or chip 2000, or a portion thereof, constitutes a means for performing one or more steps of providing user interface navigation information associated with the availability of services. Chip set or chip 2000, or a portion thereof, constitutes a means for performing one or more steps of providing operations for manipulation of distributed computations.

In one embodiment, the chip set or chip 2000 includes a communication mechanism such as a bus 2001 for passing information among the components of the chip set 2000. A processor 2003 has connectivity to the bus 2001 to execute instructions and process information stored in, for example, a memory 2005. The processor 2003 may include one or more processing cores with each core configured to perform independently. A multi-core processor enables multiprocessing within a single physical package. Examples of a multi-core processor include two, four, eight, or greater numbers of processing cores. Alternatively or in addition, the processor 2003 may include one or more microprocessors configured in tandem via the bus 2001 to enable independent execution of instructions, pipelining, and multithreading. The processor 2003 may also be accompanied with one or more specialized components to perform certain processing functions and tasks such as one or more digital signal processors (DSP) 2007, or one or more application-specific integrated circuits (ASIC) 2009. A DSP 2007 typically is configured to process real-world signals (e.g., sound) in real time independently of the processor 2003. Similarly, an ASIC 2009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 2000 includes merely one or more processors and some software and/or firmware supporting and/or relating to and/or for the one or more processors.

The processor 2003 and accompanying components have connectivity to the memory 2005 via the bus 2001. The memory 2005 includes both dynamic memory (e.g., RAM, magnetic disk, writable optical disk, etc.) and static memory (e.g., ROM, CD-ROM, etc.) for storing executable instructions that when executed perform the inventive steps described herein to provide operations for manipulation of distributed computations. The memory 2005 also stores the data associated with or generated by the execution of the inventive steps.

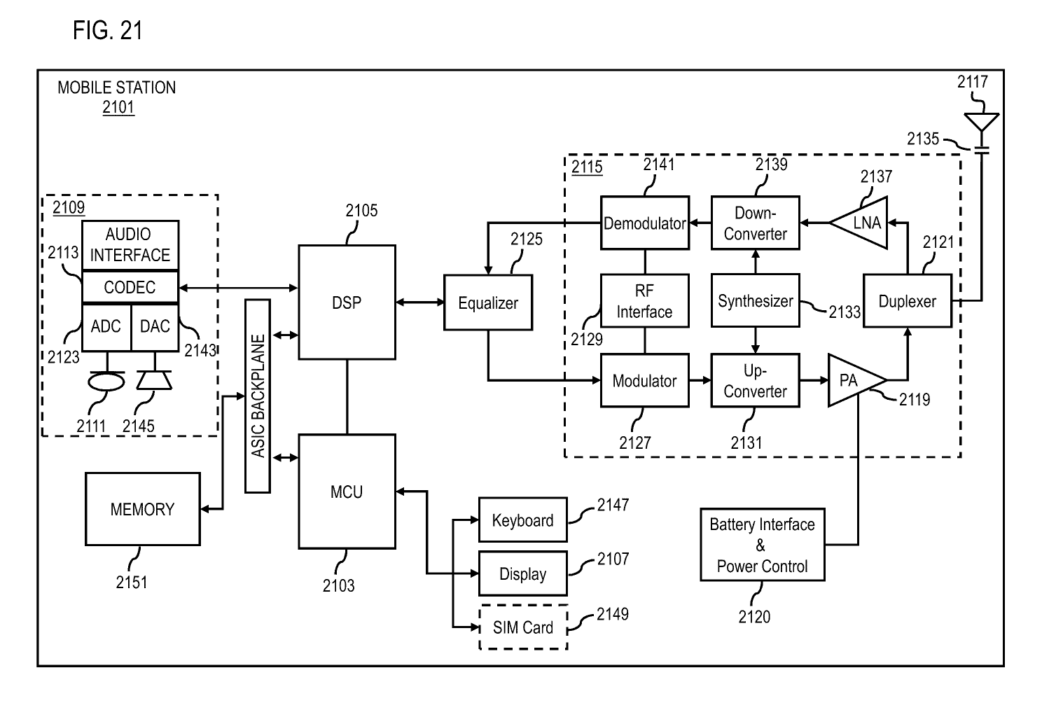

FIG. 21 is a diagram of exemplary components of a mobile terminal (e.g., handset) for communications, which is capable of operating in the system of FIG. 1, according to one embodiment. In some embodiments, mobile terminal 2101, or a portion thereof, constitutes a means for performing one or more steps of providing operations for manipulation of distributed computations. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 2103, a Digital Signal Processor (DSP) 2105, and a receiver/transmitter unit including a microphone gain control unit and a speaker gain control unit. A main display unit 2107 provides a display to the user in support of various applications and mobile terminal functions that perform or support the steps of providing operations for manipulation of distributed computations. The display 2107 includes display circuitry configured to display at least a portion of a user interface of the mobile terminal (e.g., mobile telephone). Additionally, the display 2107 and display circuitry are configured to facilitate user control of at least some functions of the mobile terminal. An audio function circuitry 2109 includes a microphone 2111 and microphone amplifier that amplifies the speech signal output from the microphone 2111. The amplified speech signal output from the microphone 2111 is fed to a coder/decoder (CODEC) 2113.

A radio section 2115 amplifies power and converts frequency in order to communicate with a base station, which is included in a mobile communication system, via antenna 2117. The power amplifier (PA) 2119 and the transmitter/modulation circuitry are operationally responsive to the MCU 2103, with an output from the PA 2119 coupled to the duplexer 2121 or circulator or antenna switch, as known in the art. The PA 2119 also couples to a battery interface and power control unit 2120.

In use, a user of mobile terminal 2101 speaks into the microphone 2111 and his or her voice along with any detected background noise is converted into an analog voltage. The analog voltage is then converted into a digital signal through the Analog to Digital Converter (ADC) 2123. The control unit 2103 routes the digital signal into the DSP 2105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 2125 for compensation of any frequency-dependent impairments that occur during transmission though the air such as phase and amplitude distortion. After equalizing the bit stream, the modulator 2127 combines the signal with a RF signal generated in the RF interface 2129. The modulator 2127 generates a sine wave by way of frequency or phase modulation. In order to prepare the signal for transmission, an up-converter 2131 combines the sine wave output from the modulator 2127 with another sine wave generated by a synthesizer 2133 to achieve the desired frequency of transmission. The signal is then sent through a PA 2119 to increase the signal to an appropriate power level. In practical systems, the PA 2119 acts as a variable gain amplifier whose gain is controlled by the DSP 2105 from information received from a network base station. The signal is then filtered within the duplexer 2121 and optionally sent to an antenna coupler 2135 to match impedances to provide maximum power transfer. Finally, the signal is transmitted via antenna 2117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 2101 are received via antenna 2117 and immediately amplified by a low noise amplifier (LNA) 2137. A down-converter 2139 lowers the carrier frequency while the demodulator 2141 strips away the RF leaving only a digital bit stream. The signal then goes through the equalizer 2125 and is processed by the DSP 2105. A Digital to Analog Converter (DAC) 2143 converts the signal and the resulting output is transmitted to the user through the speaker 2145, all under control of a Main Control Unit (MCU) 2103—which can be implemented as a Central Processing Unit (CPU) (not shown).

The MCU 2103 receives various signals including input signals from the keyboard 2147. The keyboard 2147 and/or the MCU 2103 in combination with other user input components (e.g., the microphone 2111) comprise a user interface circuitry for managing user input. The MCU 2103 runs a user interface software to facilitate user control of at least some functions of the mobile terminal 2101 to provide operations for manipulation of distributed computations. The MCU 2103 also delivers a display command and a switch command to the display 2107 and to the speech output switching controller, respectively. Further, the MCU 2103 exchanges information with the DSP 2105 and can access an optionally incorporated SIM card 2149 and a memory 2151. In addition, the MCU 2103 executes various control functions required of the terminal. The DSP 2105 may, depending upon the implementation, perform any of a variety of conventional digital processing functions on the voice signals. Additionally, DSP 2105 determines the background noise level of the local environment from the signals detected by microphone 2111 and sets the gain of microphone 2111 to a level selected to compensate for the natural tendency of the user of the mobile terminal 2101.

The CODEC 2113 includes the ADC 2123 and DAC 2143. The memory 2151 stores various data including call incoming tone data and is capable of storing other data including music data received via, e.g., the global Internet. The software module could reside in RAM memory, flash memory, registers, or any other form of writable storage medium known in the art. The memory device 2151 may be, but not limited to, a single memory, CD, DVD, ROM, RAM, EEPROM, optical storage, or any other non-volatile storage medium capable of storing digital data.

An optionally incorporated SIM card 2149 carries, for instance, important information, such as the cellular phone number, the carrier supplying service, subscription details, and security information. The SIM card 2149 serves primarily to identify the mobile terminal 2101 on a radio network. The card 2149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
determining to receive a request for specifying one or more operations to perform on one or more computation spaces, wherein the one or more computation spaces represent one or more computational processes as one or more graphs within the respective one or more computation spaces;
determining to retrieve the one or more computation spaces, the one or more graphs within the one or more computation spaces, one or more subgraphs of the one or more graphs, or a combination thereof; and
determining to apply the one or more operations on the one or more computation spaces, the one or more graphs, the one or more subgraphs, or a combination thereof to update at least one of the one or more computation spaces, to generate at least one additional computation space, or a combination thereof.

2. A method of claim 1, wherein at least one of the one or more operations is a merge operation corresponding to a first computation space of the one or more computation spaces and second computation space of the one or more computation spaces, the method further comprising:
determining to unify a first graph of the first computation space and a second graph of the second computation space; and
determining to modify the first computation space, the second computation space, the additional computation space, or a combination thereof based, at least in part, on the unification.

3. A method of claim 2, further comprising:
determining to apply a provenance operation, a conflict resolution operation, or a combination thereof on the first computation space, the second computation space, the additional computation space, or a combination thereof based, at least in part, on the unification.

4. A method of claim 1, wherein at least one of the one or more operations is a projection operation corresponding to a one of the one or more computation spaces, the method further comprising:
determining to extract a subgraph from a graph of the one computation space, wherein the additional computation space is generated based, at least in part, on the extracted subgraph; and
determining to update a set of names of projected computation spaces based, at least in part, on the generation of the additional computation space, the set of names associated with the one computation space.

5. A method of claim 4, wherein the request for the projection operation includes, at least in part, a specified subgraph, the method further comprising:
determining the one computation space based, at least in part, on the specified subgraph; and
determining a computation content, a set of rules, or a combination thereof of the one computation space based, at least in part, on a partitioning function, a deductive closure mechanism, or a combination thereof,
wherein the additional computation space is generated based, at least in part, on the computation content, the set of rules, or a combination thereof.

6. A method of claim 1, wherein at least one of the one or more operations is an injection operation corresponding to a first computation space of the one or more computation spaces and second computation space of the one or more computation spaces, and wherein the second one of the one or more computation spaces includes projected content from the first one of the one or more computation spaces, the method further comprising:
determining to filter a graph of the first one of the one or more computation spaces based at, least in part, on the projected content; and
determining to insert the graph of first one of the one or more computation spaces into a graph of the second one of the one or more computation spaces based, at least in part, on the filtering.

7. A method of claim 6, further comprising:
determining whether a name of the first one of the one or more computation spaces is in a set of names of projected computation spaces of the second one of the one or more computation spaces, wherein the inserting of the graph of the first one of the one or more computation is based, at least in part, on the determination with respect to the name; and
determining to remove the name from the set of names based, at least in part, on the determination with respect to the name.

8. A method of claim 1, wherein at least one of the one more operations is a split operation corresponding to a one of the one or more computation spaces, the method further comprising:
determining to extract a subgraph from a graph of the one computation space, wherein the additional computation space is generated based, at least in part, on the extracted subgraph; and
determining to update a set of names of split computation spaces based, at least in part, on the generation of the additional computation space, the set of names associated with the one computation space.

9. A method of claim 8, wherein the request for the split operation includes, at least in part, a specified subgraph, the method further comprising:
determining the one computation space based, at least in part, on the specified subgraph; and
determining a computation content, a set of rules, or a combination thereof of the one computation space based, at least in part, on a partitioning function, a deductive closure mechanism, a history preservation boundary, or a combination thereof,
wherein the additional computation space is generated based, at least in part, on the computation content, the set of rules, or a combination thereof.

10. A method of claim 1, further comprising:
determining a set of boundary nodes with respect to the one or more operations, the one or more computation spaces, the one or more graphs, the one or more subgraphs, or a combination thereof,
wherein the application of the one or more operations is further based, at least in part, on the set of boundary nodes.

11. An apparatus comprising:
at least one processor; and
at least one memory including computer program code,
the at least one memory and the computer program code configured to, with the at least one processor, cause the apparatus to perform at least the following,
determine to receive a request for specifying one or more operations to perform on one or more computation spaces, wherein the one or more computation spaces represent one or more computational processes as one or more graphs within the respective one or more computation spaces;
determine to retrieve the one or more computation spaces, the one or more graphs within the one or more computation spaces, one or more subgraphs of the one or more graphs, or a combination thereof; and
determine to apply the one or more operations on the one or more computation spaces, the one or more graphs, the one or more subgraphs, or a combination thereof to update at least one of the one or more computation spaces, to generate at least one additional computation space, or a combination thereof.

12. An apparatus of claim 11, wherein at least one of the one or more operations is a merge operation corresponding to a first computation space of the one or more computation spaces and second computation space of the one or more computation spaces, and wherein the apparatus is further caused to:
determine to unify a first graph of the first computation space and a second graph of the second computation space; and
determine to modify the first computation space, the second computation space, the additional computation space, or a combination thereof based, at least in part, on the unification.

13. An apparatus of claim 12, wherein the apparatus is further caused to:
determine to apply a provenance operation, a conflict resolution operation, or a combination thereof on the first computation space, the second computation space, the additional computation space, or a combination thereof based, at least in part, on the unification.

14. An apparatus of claim 11, wherein at least one of the one or more operations is a projection operation corresponding to a one of the one or more computation spaces, and wherein the apparatus is further caused to:
determine to extract of a subgraph from a graph of the one computation space, wherein the additional computation space is generated based, at least in part, on the extracted subgraph; and
determine to update a set of names of projected computation spaces based, at least in part, on the generation of the additional computation space, the set of names associated with the one computation space.

15. An apparatus of claim 14, wherein the request for the projection operation includes, at least in part, a specified subgraph, and wherein the apparatus is further caused to:
determine the one computation space based, at least in part, on the specified subgraph; and
determine a computation content, a set of rules, or a combination thereof of the one computation space based, at least in part, on a partitioning function, a deductive closure mechanism, or a combination thereof,
wherein the additional computation space is generated based, at least in part, on the computation content, the set of rules, or a combination thereof.

16. An apparatus of claim 11, wherein at least one of the one or more operations is an injection operation corresponding to a first computation space of the one or more computation spaces and second computation space of the one or more computation spaces, and wherein the second one of the one or more computation spaces includes projected content from the first one of the one or more computation spaces, and wherein the apparatus is further caused to:
determine to filter a graph of the first one of the one or more computation spaces based at, least in part, on the projected content; and
determine to insert the graph of first one of the one or more computation spaces into a graph of the second one of the one or more computation spaces based, at least in part, on the filtering.

17. An apparatus of claim 16, wherein the apparatus is further caused to:
determine whether a name of the first one of the one or more computation spaces is in a set of names of projected computation spaces of the second one of the one or more computation spaces, wherein the inserting of the graph of the first one of the one or more computation is based, at least in part, on the determination with respect to the name; and
determine to remove the name from the set of names based, at least in part, on the determination with respect to the name.

18. An apparatus of claim 11, wherein at least one of the one more operations is a split operation corresponding to a one of the one or more computation spaces, and wherein the apparatus is further caused to:
determine to extract a subgraph from a graph of the one computation space, wherein the additional computation space is generated based, at least in part, on the extracted subgraph; and
determine to update a set of names of split computation spaces based, at least in part, on the generation of the additional computation space, the set of names associated with the one computation space.

19. An apparatus of claim 18, wherein the request for the split operation includes, at least in part, a specified subgraph, and wherein the apparatus is further caused to:
determine the one computation space based, at least in part, on the specified subgraph; and
determine a computation content, a set of rules, or a combination thereof of the one computation space based, at least in part, on a partitioning function, a deductive closure mechanism, a history preservation boundary, or a combination thereof,
wherein the additional computation space is generated based, at least in part, on the computation content, the set of rules, or a combination thereof.

20. An apparatus of claim 11, wherein the apparatus is further caused to:
determine a set of boundary nodes with respect to the one or more operations, the one or more computation spaces, the one or more graphs, the one or more subgraphs, or a combination thereof,
wherein the application of the one or more operations is further based, at least in part, on the set of boundary nodes.

21.-45. (canceled)
